(19) United States
(12) Patent Application Publication
(10) Pub. No.: US 2023/0232214 A1
(43) Pub. Date: Jul. 20, 2023

(54) SELECTIVE REPORTING OF USER EQUIPMENT CAPABILITY INFORMATION

(71) Applicant: QUALCOMM Incorporated, San Diego, CA (US)

(72) Inventors: Toru UCHINO, Zushi-shi (JP); Bharat SHRESTHA, San Diego, CA (US); Umesh PHUYAL, San Diego, CA (US); Masato KITAZOE, Hachiouji-shi (JP)

(21) Appl. No.: 18/066,822

(22) Filed: Dec. 15, 2022

Related U.S. Application Data
(60) Provisional application No. 63/266,812, filed on Jan. 14, 2022.

(51) Int. Cl. H04W 8/24

(52) U.S. Cl. CPC H04W 8/24

(57) ABSTRACT

Various aspects of the present disclosure generally relate to wireless communication. In some aspects, a user equipment (UE) may receive, from a base station, a UE capability request message. The UE may transmit, to the base station in response to the UE capability request message, a UE capability information message that indicates one or more UE capabilities associated with one of a non-terrestrial network (NTN), a terrestrial network (TN), or both the NTN and the TN. Numerous other aspects are described.

### CROSS-REFERENCE TO RELATED APPLICATION

This patent application claims priority to U.S. Provisional Patent Application No. 63/266,812, filed on Jan. 14, 2022, entitled “SELECTIVE REPORTING OF USER EQUIPMENT CAPABILITY INFORMATION,” and assigned to the assignee hereof. The disclosure of the prior application is considered part of and is incorporated by reference into this patent application.

### INTRODUCTION

Aspects of the present disclosure generally relate to wireless communication and to techniques and apparatuses for reporting of user equipment (UE) capability information.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for wireless communication devices, such as a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed at an apparatus of a UE. The method may include receiving a UE capability request message. The method may include transmitting, in response to the UE capability request message, based at least in part on network information, a UE capability information message that indicates one or more UE capabilities associated with one of an NTN, a TN, or both the NTN and the TN.

Some aspects described herein relate to a method of wireless communication performed at an apparatus of a network node. The method may include transmitting a UE capability request message for a UE. The method may include receiving, in response to the UE capability request message, based at least in part on network information, a UE capability information message for the UE that indicates one or more UE capabilities associated with one of an NTN, a TN, or both the NTN and the TN.

Some aspects described herein relate to an apparatus for wireless communication at a UE. The apparatus may include a memory and one or more processors coupled to the memory. The one or more processors may be configured to receive a UE capability request message. The one or more processors may be configured to transmit, in response to the UE capability request message, based at least in part on network information, a UE capability information message that indicates one or more UE capabilities associated with one of an NTN, a TN, or both the NTN and the TN.

Some aspects described herein relate to an apparatus for wireless communication at a network node. The apparatus may include a memory and one or more processors coupled to the memory. The one or more processors may be configured to transmit a UE capability request message for a UE. The one or more processors may be configured to receive, in response to the UE capability request message, based at least in part on network information, a UE capability information message for the UE that indicates one or more UE capabilities associated with one of an NTN, a TN, or both the NTN and the TN.

Some aspects described herein relate to a non-transitory computer-readable medium that stores a set of instructions for wireless communication by a UE. The set of instructions, when executed by one or more processors of the UE, may cause the UE to receive a UE capability request message. The set of instructions, when executed by the one or more processors of the UE, may cause the UE to transmit, in response to the UE capability request message, based at least in part on network information, a UE capability information message that indicates one or more UE capabilities associated with one of an NTN, a TN, or both the NTN and the TN.

Some aspects described herein relate to a non-transitory computer-readable medium that stores a set of instructions for wireless communication by a network node. The set of instructions, when executed by one or more processors of the network node, may cause the network node to transmit a UE capability request message for a UE. The set of instructions, when executed by the one or more processors of the network node, may cause the network node to receive, in response to the UE capability request message, based at least in part on network information, a UE capability information message for the UE that indicates one or more UE capabilities associated with one of an NTN, a TN, or both the NTN and the TN.

Some aspects described herein relate to an apparatus for wireless communication. The apparatus may include means for receiving a UE capability request message. The apparatus may include means for transmitting, in response to the UE capability request message, based at least in part on network information, a UE capability information message that indicates one or more UE capabilities associated with one of an NTN, a TN, or both the NTN and the TN.

Some aspects described herein relate to an apparatus for wireless communication. The apparatus may include means for transmitting a UE capability request message for a UE. The apparatus may include means for receiving, in response to the UE capability request message, based at least in part on network information, a UE capability information message for the UE that indicates one or more UE capabilities associated with one of an NTN, a TN, or both the NTN and the TN.

Some aspects described herein relate to a method of wireless communication performed by an apparatus of a user equipment (UE). The method may include receiving, from a base station, a UE capability request message. The method may include transmitting, to the base station in response to the UE capability request message, a UE capability information message that indicates one or more UE capabilities associated with one of a non-terrestrial network (NTN), a terrestrial network (TN), or both the NTN and the TN.

Some aspects described herein relate to a method of wireless communication performed by an apparatus of a base station. The method may include transmitting, to a UE, a UE capability request message. The method may include receiving, from the UE in response to the UE capability request message, a UE capability information message that indicates one or more UE capabilities associated with one of an NTN, a TN, or both the NTN and the TN.

Some aspects described herein relate to a method of wireless communication performed by an apparatus of a UE. The method may include receiving, from a base station, a UE capability request message. The method may include transmitting, to the base station in response to the UE capability request message, a UE capability information message that indicates one or more UE capabilities associated with one of unlicensed spectrum, licensed spectrum, or both unlicensed spectrum and licensed spectrum.

Some aspects described herein relate to a method of wireless communication performed by an apparatus of a base station. The method may include transmitting, to a UE, a UE capability request message. The method may include receiving, from the UE in response to the UE capability request message, a UE capability information message that indicates one or more UE capabilities associated with one of unlicensed spectrum, licensed spectrum, or both unlicensed spectrum and licensed spectrum.

Some aspects described herein relate to an apparatus for wireless communication at a UE. The apparatus may include a memory and one or more processors coupled to the memory. The one or more processors may be configured to receive, from a base station, a UE capability request message. The one or more processors may be configured to transmit, to the base station in response to the UE capability request message, a UE capability information message that indicates one or more UE capabilities associated with one of an NTN, a TN, or both the NTN and the TN.

Some aspects described herein relate to an apparatus for wireless communication at a base station. The apparatus may include a memory and one or more processors coupled to the memory. The one or more processors may be configured to transmit, to a UE, a UE capability request message. The one or more processors may be configured to receive, from the UE in response to the UE capability request message, a UE capability information message that indicates one or more UE capabilities associated with one of an NTN, a TN, or both the NTN and the TN.

Some aspects described herein relate to an apparatus for wireless communication at a UE. The apparatus may include a memory and one or more processors coupled to the memory. The one or more processors may be configured to receive, from a base station, a UE capability request message. The one or more processors may be configured to transmit, to the base station in response to the UE capability request message, a UE capability information message that indicates one or more UE capabilities associated with one of unlicensed spectrum, licensed spectrum, or both unlicensed spectrum and licensed spectrum.

Some aspects described herein relate to an apparatus for wireless communication at a base station. The apparatus may include a memory and one or more processors coupled to the memory. The one or more processors may be configured to transmit, to a UE, a UE capability request message. The one or more processors may be configured to receive, from the UE in response to the UE capability request message, a UE capability information message that indicates one or more UE capabilities associated with one of unlicensed spectrum, licensed spectrum, or both unlicensed spectrum and licensed spectrum.

Some aspects described herein relate to a non-transitory computer-readable medium that stores a set of instructions for wireless communication by a UE. The set of instructions, when executed by one or more processors of the UE, may cause the UE to receive, from a base station, a UE capability request message. The set of instructions, when executed by the one or more processors of the UE, may cause the UE to transmit, to the base station in response to the UE capability request message, a UE capability information message that indicates one or more UE capabilities associated with one of an NTN, a TN, or both the NTN and the TN.

Some aspects described herein relate to a non-transitory computer-readable medium that stores a set of instructions for wireless communication by a base station. The set of instructions, when executed by one or more processors of the base station, may cause the base station to transmit, to a UE, a UE capability request message. The set of instructions, when executed by the one or more processors of the base station, may cause the base station to receive, from the UE in response to the UE capability request message, a UE capability information message that indicates one or more UE capabilities associated with one of an NTN, a TN, or both the NTN and the TN.

Some aspects described herein relate to a non-transitory computer-readable medium that stores a set of instructions for wireless communication by a UE. The set of instructions, when executed by one or more processors of UE, may cause the UE to receive, from a base station, a UE capability request message. The set of instructions, when executed by the one or more processors of the UE, may cause the UE to transmit, to the base station in response to the UE capability request message, a UE capability information message that indicates one or more UE capabilities associated with one of unlicensed spectrum, licensed spectrum, or both unlicensed spectrum and licensed spectrum.

Some aspects described herein relate to a non-transitory computer-readable medium that stores a set of instructions for wireless communication by a base station. The set of instructions, when executed by one or more processors of the base station, may cause the base station to transmit, to a UE, a UE capability request message. The set of instructions, when executed by the one or more processors of the base station, may cause the base station to receive, from the UE in response to the UE capability request message, a UE capability information message that indicates one or more UE capabilities associated with one of unlicensed spectrum, licensed spectrum, or both unlicensed spectrum and licensed spectrum.

Some aspects described herein relate to an apparatus for wireless communication. The apparatus may include means for receiving, from a base station, a UE capability request message. The apparatus may include means for transmitting, to the base station in response to the UE capability request message, a UE capability information message that indicates one or more UE capabilities associated with one of an NTN, a TN, or both the NTN and the TN.

Some aspects described herein relate to an apparatus for wireless communication. The apparatus may include means for transmitting, to a UE, a UE capability request message. The apparatus may include means for receiving, from the UE in response to the UE capability request message, a UE capability information message that indicates one or more UE capabilities associated with one of an NTN, a TN, or both the NTN and the TN.

Some aspects described herein relate to an apparatus for wireless communication. The apparatus may include means for receiving, from a base station, a UE capability request message. The apparatus may include means for transmitting, to the base station in response to the UE capability request message, a UE capability information message that indicates one or more UE capabilities associated with one of unlicensed spectrum, licensed spectrum, or both unlicensed spectrum and licensed spectrum.

Some aspects described herein relate to an apparatus for wireless communication. The apparatus may include means for transmitting, to a UE, a UE capability request message. The apparatus may include means for receiving, from the UE in response to the UE capability request message, a UE capability information message that indicates one or more UE capabilities associated with one of unlicensed spectrum, licensed spectrum, or both unlicensed spectrum and licensed spectrum.

Aspects generally include a method, apparatus, system, computer program product, non-transitory computer-readable medium, user equipment, base station, network entity, network node, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating an example of a regenerative satellite deployment and an example of a transparent satellite deployment in a non-terrestrial network (NTN), in accordance with the present disclosure.

FIG. 5 is a diagram illustrating an example of an unlicensed radio frequency band and a licensed radio frequency band, in accordance with the present disclosure.

FIGS. 6A-6B are diagrams illustrating examples of UE capability reporting, in accordance with the present disclosure.

FIGS. 7-8 are diagrams illustrating examples associated with selective reporting of UE capability information, in accordance with the present disclosure.

FIGS. 9-12 are diagrams illustrating example processes associated with selective reporting of UE capability information, in accordance with the present disclosure.

FIG. 13 is a diagram of an example apparatus for wireless communication, in accordance with the present disclosure.

FIG. 14 is a diagram illustrating an example of a hardware implementation for an apparatus employing a processing system, in accordance with the present disclosure.

FIG. 15 is a diagram illustrating an example implementation of code and circuitry for an apparatus, in accordance with the present disclosure.

FIG. 16 is a diagram of an example apparatus for wireless communication, in accordance with the present disclosure.

FIG. 17 is a diagram illustrating an example of a hardware implementation for an apparatus employing a processing system, in accordance with the present disclosure.

FIG. 18 is a diagram illustrating an example implementation of code and circuitry for an apparatus, in accordance with the present disclosure.

FIGS. 19-20 are diagrams illustrating example processes associated with selective reporting of UE capability information, in accordance with the present disclosure.

### DETAILED DESCRIPTION

A user equipment (UE) may report UE capability information, indicating one or more UE capabilities, to a base station. The UE capability information may indicate per-band capabilities of the UE (i.e., UE capabilities relating to bands or band combinations) for one or more bands or band combinations and/or indicate per-UE capabilities of the UE (i.e., UE capabilities that are band independent, such as UE capabilities that indicate capabilities other than supported bands or band combinations). That is, the UE capability information for the UE may collectively include the per-band capabilities and per-UE capabilities of the UE. The per-band capabilities may indicate supported bands or band combinations (e.g., by band number), support for aperiodic beam reporting, and/or a beam reporting timing capability, among other examples. The per-UE capabilities may indicate support for a radio resource control (RRC) inactive state, support for a 2-step random-access channel (RACH) procedure, and/or measurement capabilities, among other examples.

A UE may communicate using a non-terrestrial network (NTN) and/or a terrestrial network (TN). A set of capabilities of the UE for an NTN may be different from a set of capabilities of the UE for a TN. Accordingly, the UE may separately report such different sets of UE capabilities to a base station. For example, the UE may transmit a UE capability information message that indicates band-related capabilities of the UE (e.g., per-band capabilities of the UE), per-UE capabilities of the UE for a TN, and per-UE capabilities of the UE for an NTN. Many, or all, of the information elements of the UE capability information message used for reporting per-UE capabilities for an NTN may be duplicates of information elements of the UE capability information message used for reporting per-UE capabilities for a TN. Thus, a size of the UE capability information message may be relatively large, thereby consuming significant network resources.

In some cases, a UE may provide an indication as to whether the UE supports NTN access in a UE capability information message. In one example, the UE may not include per-band UE capabilities associated with NTN bands, but include an indication that the UE supports NTN access, in a UE capability information message transmitted by the UE when accessing a TN. For example, the UE may do so when a transport block size is limited, and TN access is prioritized. Here, a base station may transmit a UE capability request message to obtain UE capabilities for an NTN at a later time while the UE is still in the same TN, before mobility/handover of the UE to an NTN is to be triggered, or after the UE has moved to an NTN. In another example, per-UE capabilities indicated by the UE in a UE capability information message may be applicable to both a TN and an NTN when the UE indicates support for NTN access but does not indicate any per-band UE capabilities associated with NTN bands. Here, the base station may transmit a UE capability request message for the UE to provide per-band UE capabilities, or all UE capabilities, for an NTN at a later time when there is bandwidth available.

To reduce the size of the UE capability information message, a base station may provide a band filtering indication to a UE. The band filtering indication may indicate the bands or band combinations for which the UE is to report per-band capabilities in the UE capability information. For example, the band filtering indication may indicate one or more TN bands or band combinations and/or one or more NTN bands or band combinations for which the UE is to report per-band capabilities.

However, a similar filtering indication does not exist for per-UE capabilities. Thus, a UE may report per-UE capabilities for both an NTN and a TN in the UE capability information in all reporting scenarios, or the UE may report per-UE capabilities for only one of an NTN or a TN in the UE capability information in all reporting scenarios. Reporting per-UE capabilities for both an NTN and a TN in a case when a base station needs UE capability information for only one of an NTN or a TN results in overhead and consumes additional network resources. Similarly, reporting per-UE capabilities for only one of an NTN or a TN in a case when a base station needs UE capability information for both an NTN and a TN results in the base station receiving an incomplete set of UE capability information for the UE. As a result, the base station may transmit multiple requests for UE capability information in order to obtain the per-UE capability information for both an NTN and a TN, thereby consuming additional network resources, and/or the base station may configure the UE based on the incomplete UE capability information. Similar circumstances may arise in connection with reporting UE capability information for licensed spectrum and unlicensed spectrum (e.g., a UE may have different per-UE capabilities for licensed spectrum and unlicensed spectrum, and therefore the UE may need to separately report such different capabilities).

Some techniques and apparatuses described herein provide for selective reporting of UE capability information, and in particular, selective reporting of per-UE capabilities (e.g., band-independent capabilities) of the UE capability information. For example, in a case when a base station could utilize UE capability information for an NTN or for a TN, a UE may likewise report UE capability information for an NTN or for a TN. Accordingly, overhead associated with reporting UE capability information for both an NTN and a TN is reduced. As another example, in a case when the base station could utilize UE capability information for both an NTN and a TN, a UE may likewise report UE capability information for both an NTN and a TN. Accordingly, multiple requests for UE capability information and/or the base station configuring the UE according to an incomplete set of UE capability information, which may result from reporting UE capability information for an NTN or for a TN where the base station could utilize UE capability for both an NTN and a TN, may be avoided.

In some aspects, a UE may receive an explicit indication from a base station of whether the UE is to report UE capability information for an NTN, a TN, or both an NTN and a TN. In some aspects, a UE may determine whether the UE is to report UE capability information for an NTN, a TN, or both an NTN and a TN based at least in part on network information (e.g., which may indicate that the UE is in a coverage of an NTN and/or a TN) and/or UE information (e.g., which may indicate whether communication using an NTN and/or a TN is likely for the UE).

In a similar manner, a UE may selectively report UE capability information for one of licensed spectrum or unlicensed spectrum or both licensed spectrum and unlicensed spectrum. For example, in a case when a base station could utilize UE capability information for one of unlicensed spectrum or licensed spectrum, a UE may likewise report UE capability information for the one of unlicensed spectrum or licensed spectrum that could be utilized by the base station. Accordingly, overhead associated with reporting UE capability information for both unlicensed spectrum and licensed spectrum where the base station could utilize UE capability information for one of unlicensed spectrum or licensed spectrum is reduced. As another example, in a case when the base station could utilize UE capability information for both unlicensed spectrum and licensed spectrum, a UE may likewise report UE capability information for both unlicensed spectrum and licensed spectrum. Accordingly, multiple requests for UE capability information and/or the base station configuring the UE according to an incomplete set of UE capability information, which may result from reporting UE capability information for one unlicensed spectrum or licensed spectrum where the base station could utilize UE capability for both unlicensed spectrum and licensed spectrum, may be avoided.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

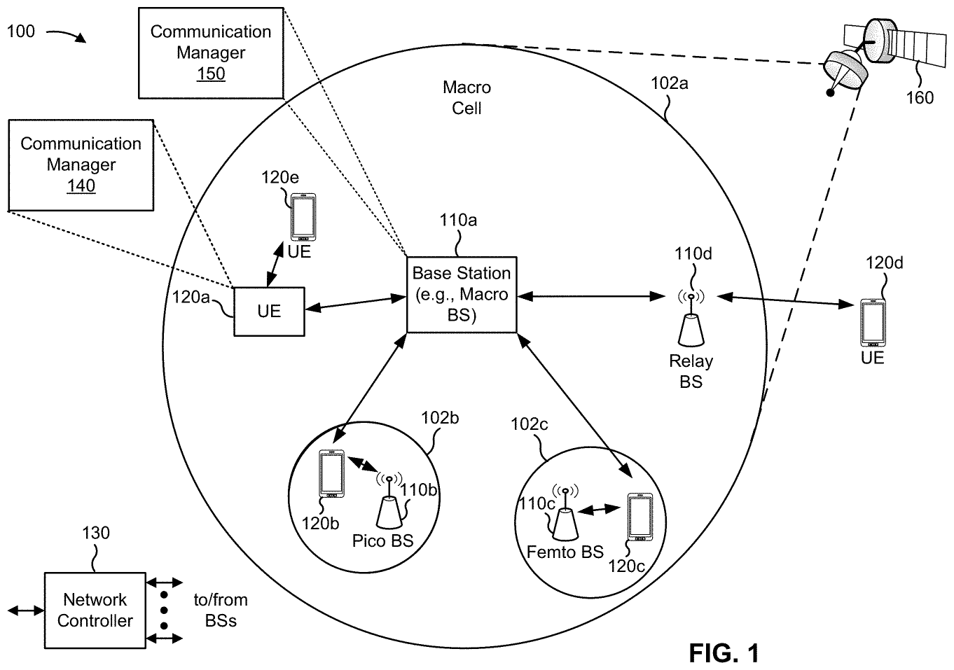

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a UE 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

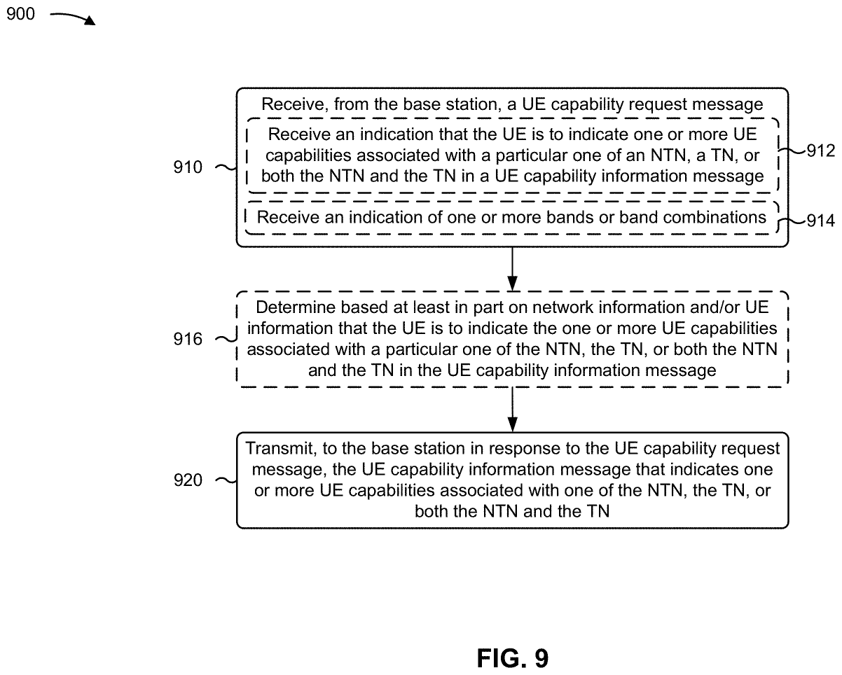

In some aspects, the terms “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station,” “network node,” or “network entity” may refer to one device configured to perform one or more functions, such as those described herein in connection with the base station 110. In some aspects, the terms “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station,” “network node,” or “network entity” may refer to any one or more of those different devices. In some aspects, the terms “base station,” “network node,” or “network entity” may refer to one or more virtual base stations and/or one or more virtual base station functions. For example, in some aspects, two or more base station functions may be instantiated on a single device. In some aspects, the terms “base station,” “network node,” or “network entity” may refer to one of the base station functions and not another. In this way, a single device may include more than one base station.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link or a midhaul communication link. The base stations 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a base station, a UE capability request message; and transmit, to the base station in response to the UE capability request message, a UE capability information message that indicates one or more UE capabilities associated with one of an NTN, a TN, or both the NTN and the TN. As described in more detail elsewhere herein, the communication manager 140 may receive, from a base station, a UE capability request message; and transmit, to the base station in response to the UE capability request message, a UE capability information message that indicates one or more UE capabilities associated with one of unlicensed spectrum, licensed spectrum, or both unlicensed spectrum and licensed spectrum. Additionally, or alternatively, the communication manager 140 may perform one or more other operations described herein.

In some aspects, the base station 110 may include a communication manager 150. As described in more detail elsewhere herein, the communication manager 150 may transmit, to a UE, a UE capability request message; and receive, from the UE in response to the UE capability request message, a UE capability information message that indicates one or more UE capabilities associated with one of an NTN, a TN, or both the NTN and the TN. As described in more detail elsewhere herein, the communication manager 150 may transmit, to a UE, a UE capability request message; and receive, from the UE in response to the UE capability request message, a UE capability information message that indicates one or more UE capabilities associated with one of unlicensed spectrum, licensed spectrum, or both unlicensed spectrum and licensed spectrum. Additionally, or alternatively, the communication manager 150 may perform one or more other operations described herein.

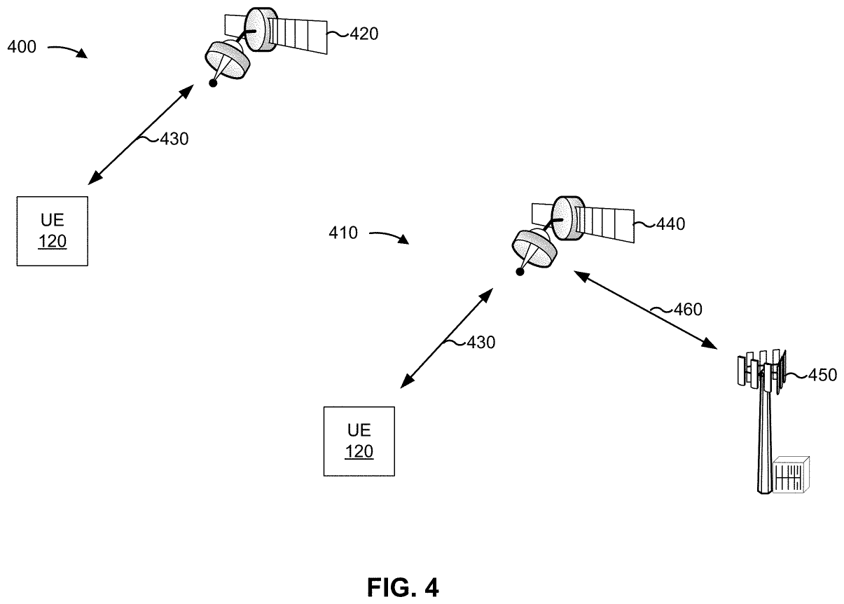

In some aspects, as shown in FIG. 1, a cell may be provided by a base station 110 used in an NTN. The NTN may include an NTN entity 160 (e.g., satellite, a balloon, a dirigible, an airplane, an unmanned aerial vehicle, or a high altitude platform station). The base station 110 of the NTN may be a base station carried by the NTN entity 160 (regenerative deployment) or a base station on the ground that communicates via the NTN entity 160 (bent-pipe or transparent deployment), as described in connection with FIG. 4. In a TN, communication may be performed without the use of an NTN entity.

As indicated above, FIG. 1 is provided as an example. Other examples may differ from what is described with regard to FIG. 1.

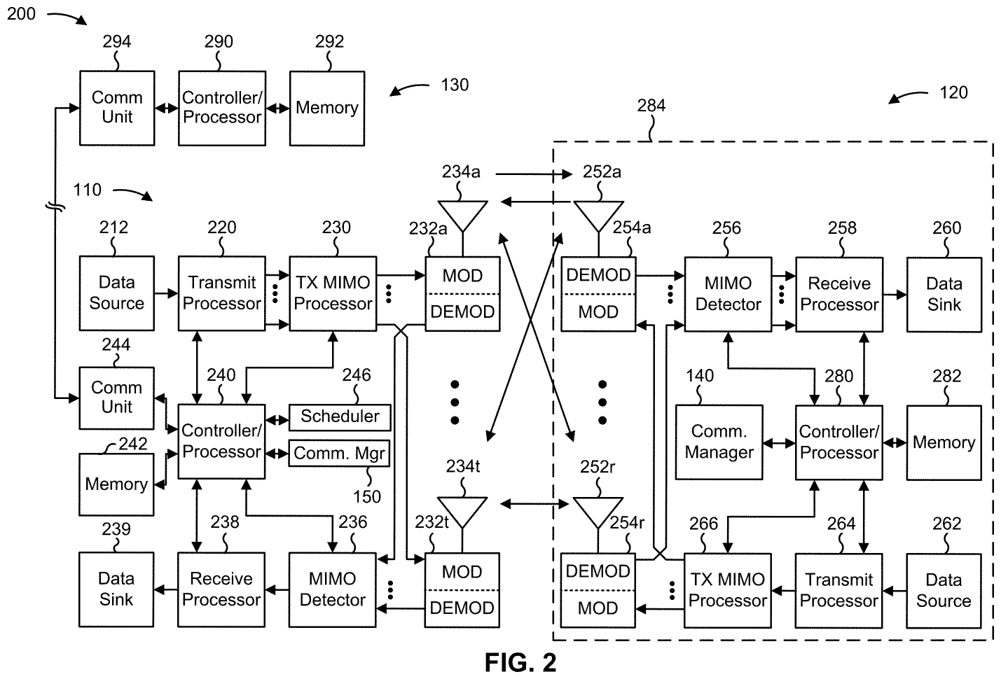

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

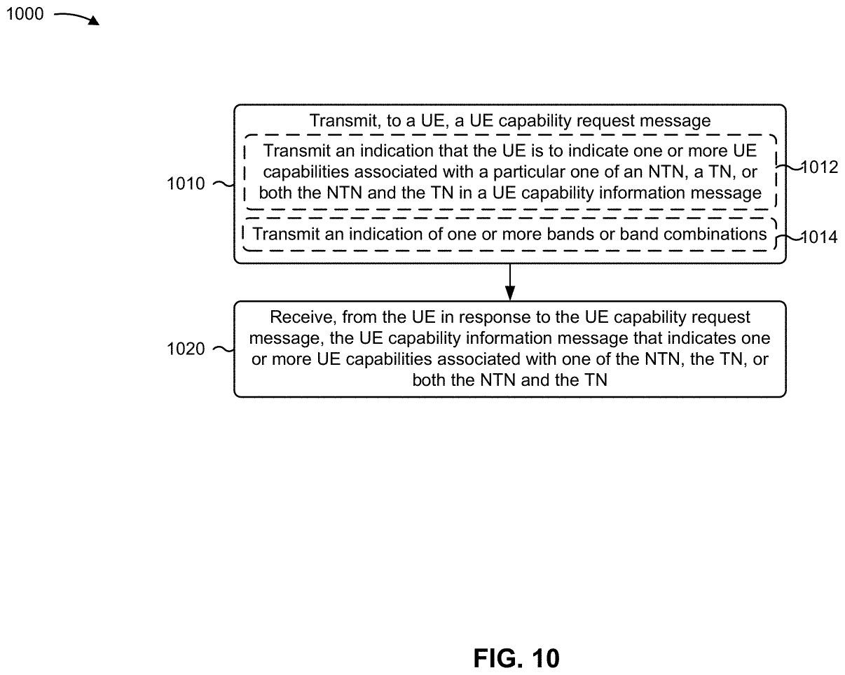

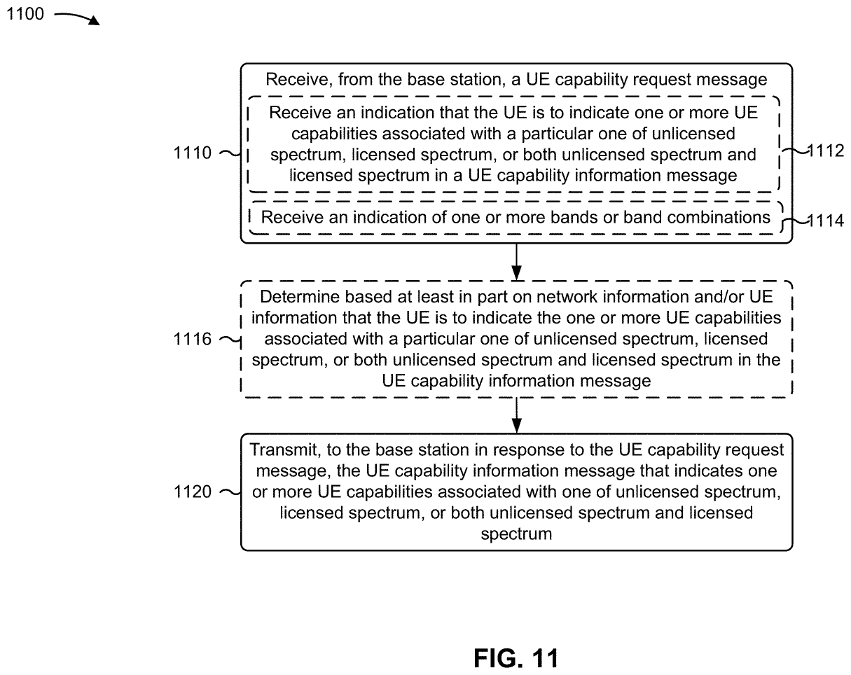

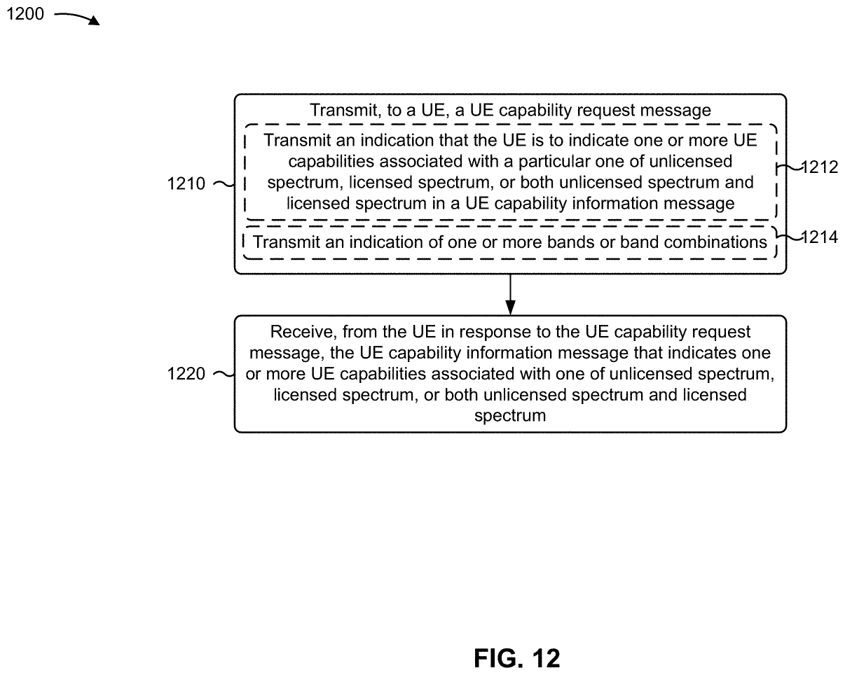

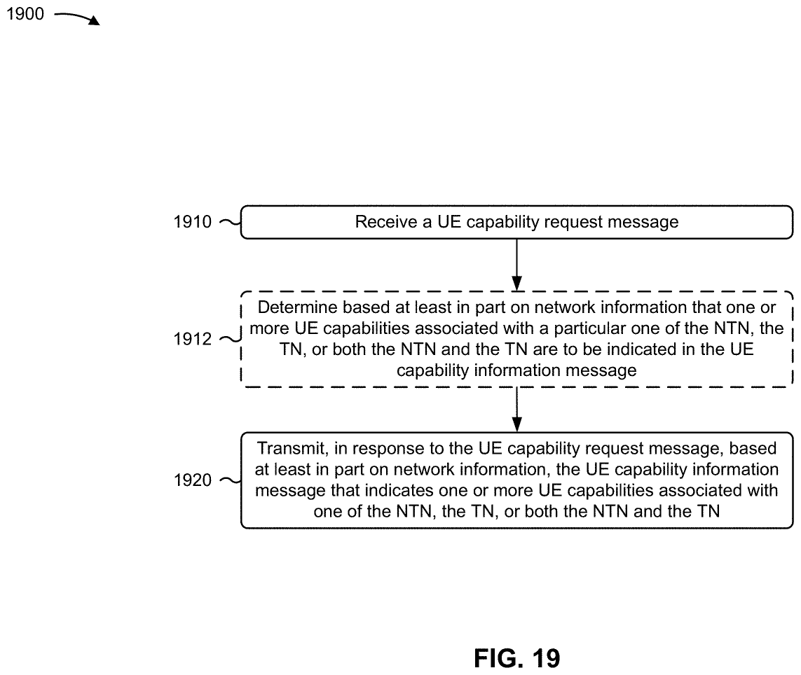

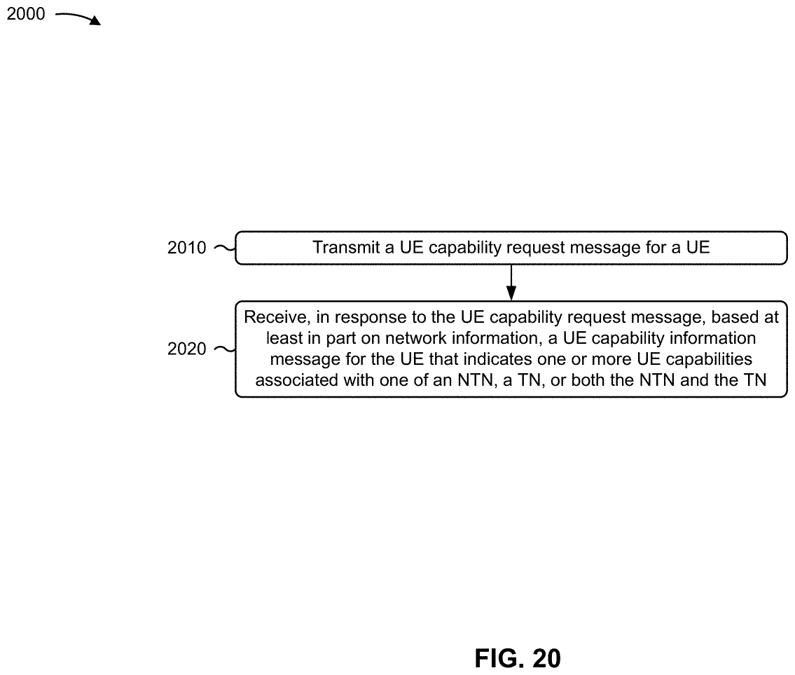

The controller/processor 240 of the base station 110, the controller/processor 280 of the UE 120, and/or any other component(s) of FIG. 2 may perform one or more techniques associated with selective reporting of UE capability information, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, process 1900 of FIG. 19, process 2000 of FIG. 20, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, process 1100 of FIG. 11, process 1200 of FIG. 12, process 1900 of FIG. 19, process 2000 of FIG. 20, and/or other processes as described herein. In some examples, executing instructions may include running the instructions, converting the instructions, compiling the instructions, and/or interpreting the instructions, among other examples.

In some aspects, the UE includes means for receiving, from a base station, a UE capability request message; and/or means for transmitting, to the base station in response to the UE capability request message, a UE capability information message that indicates one or more UE capabilities associated with one of an NTN, a TN, or both the NTN and the TN. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting, to a UE, a UE capability request message; and/or means for receiving, from the UE in response to the UE capability request message, a UE capability information message that indicates one or more UE capabilities associated with one of an NTN, a TN, or both the NTN and the TN. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE includes means for receiving, from a base station, a UE capability request message; and/or means for transmitting, to the base station in response to the UE capability request message, a UE capability information message that indicates one or more UE capabilities associated with one of unlicensed spectrum, licensed spectrum, or both unlicensed spectrum and licensed spectrum. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting, to a UE, a UE capability request message; and/or means for receiving, from the UE in response to the UE capability request message, a UE capability information message that indicates one or more UE capabilities associated with one of unlicensed spectrum, licensed spectrum, or both unlicensed spectrum and licensed spectrum. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

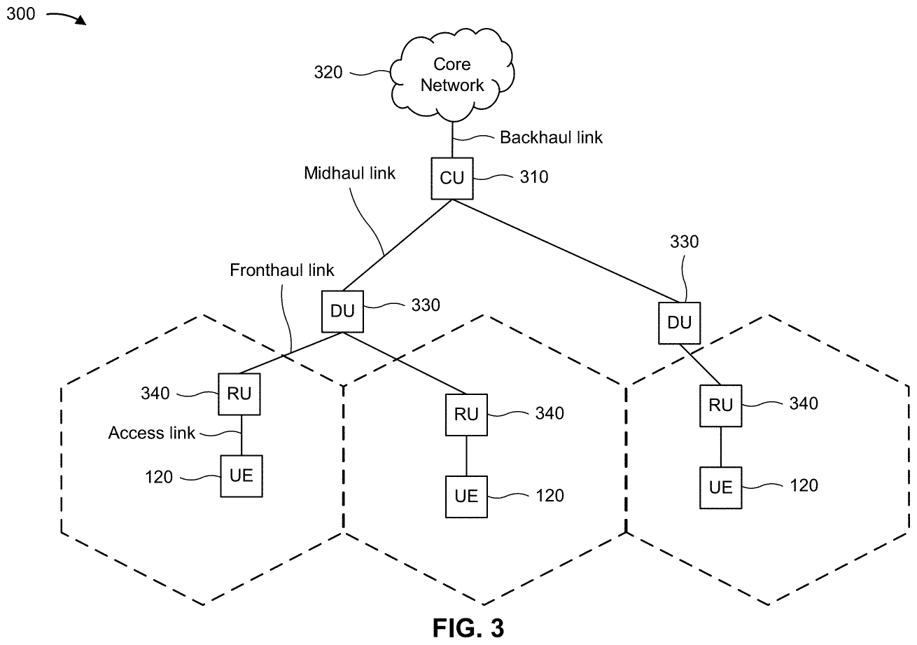

FIG. 3 is a diagram illustrating an example 300 of an open radio access network (O-RAN) architecture, in accordance with the present disclosure. As shown in FIG. 3, the O-RAN architecture may include a CU 310 that communicates with a core network 320 via a backhaul link. Furthermore, the CU 310 may communicate with one or more DUs 330 via respective midhaul links. The DUs 330 may each communicate with one or more RUs 340 via respective fronthaul links, and the RUs 340 may each communicate with respective UEs 120 via radio frequency (RF) access links. The DUs 330 and the RUs 340 may also be referred to as O-RAN DUs (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

FIG. 4 is a diagram illustrating an example 400 of a regenerative satellite deployment and an example 410 of a transparent satellite deployment in an NTN, in accordance with the present disclosure.

Example 400 shows a regenerative satellite deployment. In example 400, a UE 120 is served by a satellite 420 via a service link 430. For example, the satellite 420 may include a BS 110 (e.g., BS 110a) or a gNB. In some aspects, the satellite 420 may be referred to as a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120).

The feeder link 460 and the service link 430 may each experience Doppler effects due to the movement of the satellites 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 120 to drift from a target downlink frequency.

A UE 120 may have a set of UE capabilities for communication in an NTN that are different from a set of UE capabilities of the UE 120 for communication in a TN.

As indicated above, FIG. 4 is provided as an example. Other examples may differ from what is described with regard to FIG. 4.

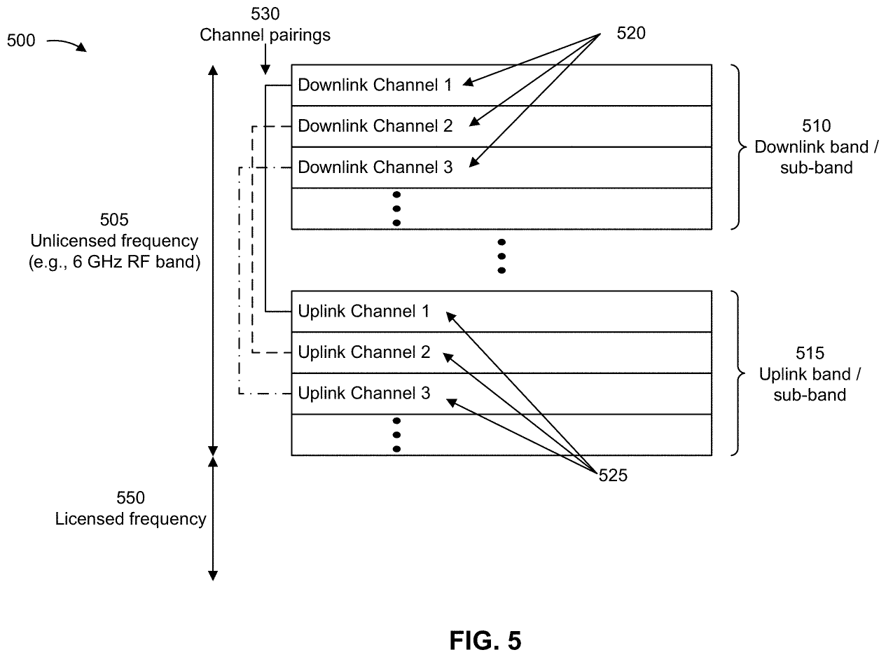

FIG. 5 is a diagram illustrating an example 500 of an unlicensed radio frequency band and a licensed radio frequency band, in accordance with the present disclosure.

To accommodate increasing traffic demands, there have been various efforts to improve spectral efficiency in wireless networks and thereby increase network capacity (e.g., via use of higher order modulations, advanced MIMO antenna technologies, multi-cell coordination techniques, and/or the like). Another way to potentially improve network capacity is to expand system bandwidth. However, as shown by the licensed RF band 550, available spectrum in lower frequency bands that have traditionally been licensed or otherwise allocated to mobile network operators has become very scarce. Accordingly, various technologies have been developed to enable a cellular radio access technology (RAT) to operate in unlicensed or other shared spectrum. For example, Licensed-Assisted Access (LAA) uses carrier aggregation on a downlink to combine LTE in a licensed frequency band with LTE in an unlicensed frequency band (e.g., the 2.4 and/or 5 GHz bands already populated by wireless local area network (WLAN) or “Wi-Fi” devices). In other examples, Enhanced LAA (eLAA) and Further Enhanced LAA (feLAA) technologies enable both uplink and downlink LTE operation in unlicensed spectrum, MulteFire is an LTE-based technology that operates in unlicensed and shared spectrum in a standalone mode, NR unlicensed (NR-U) enables NR operation in unlicensed spectrum, or the like.

For example, as shown in FIG. 5, and by reference number 505, an unlicensed RF band, such as a 6 GHz unlicensed RF band, may span a frequency range and may utilize frequency division duplexing (FDD). In an FDD system, a first band (e.g., a first sub-band of the unlicensed RF band) may be used for downlink communication, as shown by reference number 510, and a second band (e.g., a second sub-band of the unlicensed RF band) may be used for uplink communication, as shown by reference number 515. Downlink communication may refer to communication from a control node to a node (e.g., that is controlled, configured, and/or scheduled by the control node), such as from a base station to a UE, from a WLAN access point to a WLAN station, or the like. Uplink communication may refer to communication from the node to the control node, such as from a UE to a base station, from a WLAN station to a WLAN access point, or the like.

As further shown in FIG. 5, and by reference number 520, the downlink band may be divided into multiple downlink channels, sometimes referred to as downlink frequency channels. Similarly, as shown by reference number 525, the uplink band may be divided into multiple uplink channels, sometimes referred to as uplink frequency channels. As shown by reference number 530, each downlink channel may correspond to a single uplink channel. This may be referred to as channel pairing, where a downlink channel is paired with an uplink channel. In this configuration, a control node and a node may use a particular downlink channel for downlink communication, and may use a particular uplink channel, that is paired with or corresponds to the particular downlink channel, for uplink communication. In example 500, downlink channel 1 is paired with uplink channel 1, downlink channel 2 is paired with uplink channel 2, downlink channel 3 is paired with uplink channel 3, and so on.

While the example 500 illustrated in FIG. 5 shows an unlicensed RF band that utilizes FDD, in some cases, an unlicensed communication channel may utilize time division duplexing (TDD). For example, in an unlicensed communication channel that utilizes TDD, uplink and downlink transmissions may be separated in time and conducted on the same frequency channel. However, unlike TDD in licensed spectrum, a subframe, slot, symbol, or the like, is not restricted to being configured for uplink communication or downlink communication, and may be configured for downlink transmissions by a base station or for uplink transmissions by a UE. Furthermore, unlicensed communication may support dynamic TDD, where an uplink-downlink allocation may change over time to adapt to traffic conditions. For example, to enable dynamic TDD, a wireless device (e.g., a base station, a UE, or the like) may determine when to transmit and in which resource to transmit according to an indication of a channel occupancy time structure. In general, the channel occupancy time may include multiple transmission intervals (e.g., multiple slots), and each transmission interval may include one or more downlink resources, one or more uplink resources, one or more flexible resources, or the like. In this way, the channel occupancy time structure reduces power consumption, channel access delay, or the like.

A UE 120 may have a set of UE capabilities for communication in unlicensed spectrum that are different from a set of UE capabilities of the UE 120 for communication in licensed spectrum.

As indicated above, FIG. 5 is provided as an example. Other examples may differ from what is described with regard to FIG. 5.

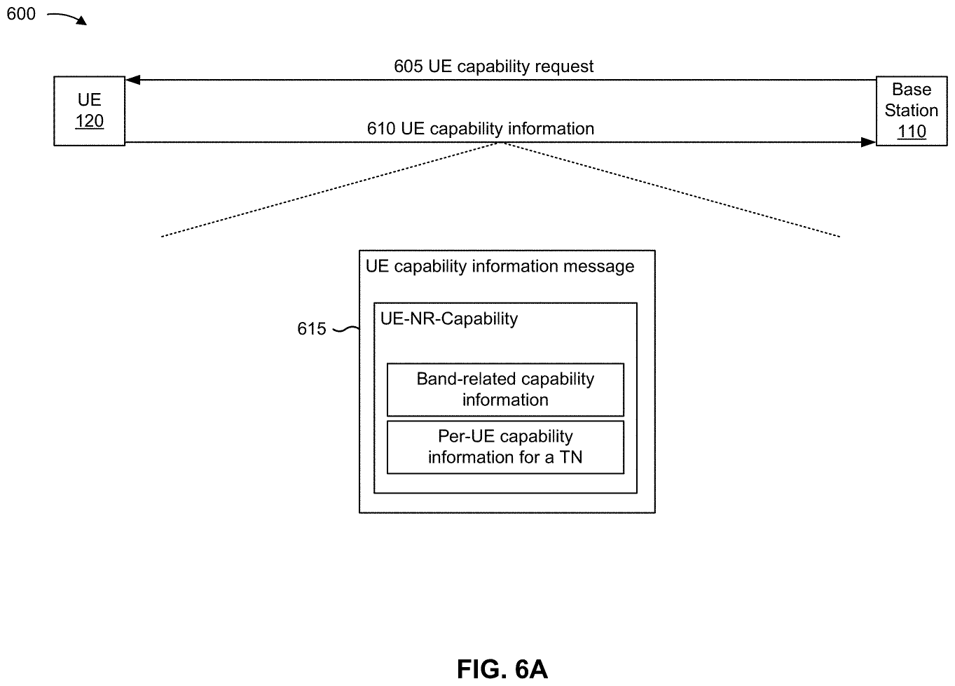

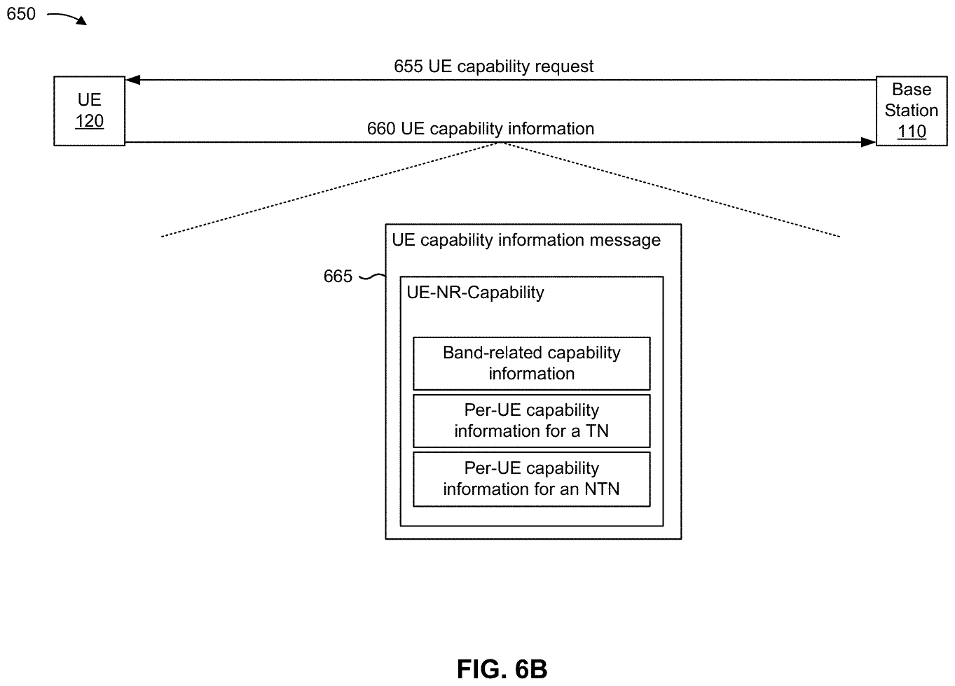

FIG. 6A is a diagram illustrating an example 600 of UE capability reporting, in accordance with the present disclosure.

As shown by reference number 605, a base station 110 may transmit a UE capability request message to a UE 120. The UE capability request message may indicate that the base station 110 is requesting UE capability information from the UE 120. In particular, the UE capability request message may identify one or more RATs for which the base station 110 is requesting UE capability information. The base station 110 may transmit the UE capability request message via RRC signaling.

As shown by reference number 610, the UE 120, in response to the UE capability request message, may transmit a UE capability information message to the base station 110. The UE capability information message may indicate one or more UE capabilities that are supported by the UE 120 (e.g., for the one or more RATs identified by the UE capability request message). In particular, the UE capability information message may indicate per-band capabilities (that is, band-level capabilities) of the UE 120 for a plurality of bands or band combinations and/or per-UE capabilities (that is, UE-level capabilities that are band independent) of the UE 120. A UE capability information message 615 may indicate UE capabilities for an NR RAT (UE-NR-Capability). The UE capability information message 615 may include band-related capability information (i.e., per-band capability information) and per-UE capability information associated with a TN. Thus, the UE capability information message 615 may not support reporting of per-UE capability information associated with an NTN.

FIG. 6B is a diagram illustrating an example 650 of UE capability reporting, in accordance with the present disclosure.

As shown by reference number 655, a base station 110 may transmit a UE capability request message to a UE 120. The UE capability request message may indicate that the base station 110 is requesting UE capability information from the UE 120. In particular, the UE capability request message may identify one or more RATs for which the base station 110 is requesting UE capability information. The base station 110 may transmit the UE capability request message via RRC signaling.

As shown by reference number 660, the UE 120, in response to the UE capability request message, may transmit a UE capability information message to the base station 110. The UE capability information message may indicate one or more UE capabilities that are supported by the UE 120 (e.g., for the one or more RATs identified by the UE capability request message). In particular, the UE capability information message may indicate per-band capabilities (that is, band-level capabilities) of the UE 120 for a plurality of bands or band combinations and/or per-UE capabilities (that is, UE-level capabilities that are band independent) of the UE 120.

In scenarios in which an NTN is used as a complement for a TN (e.g., in rural areas, atop a mountain, at sea, in the sky, or the like), it is sufficient for the UE 120 to report UE capability information associated with an NTN to a base station 110 for the NTN. Similarly, in such scenarios, it is sufficient for the UE 120 to report UE capability information associated with a TN to a base station 110 for the TN. However, in other scenarios involving interaction between a TN and an NTN (e.g., TN-NTN mobility, TN-NTN carrier aggregation, TN-NTN dual connectivity, or the like), a base station 110 may utilize UE capability information associated with a TN and an NTN. Thus, a UE capability information message 665 may include band-related capability information, per-UE capability information for a TN, and per-UE capability information for an NTN (e.g., as an extension of the existing container based on an assumption that there are no significant differences between a TN capability set and an NTN capability set to justify defining separate capabilities for the NTN capability set). The per-UE capability information for an NTN field (e.g., UE-NR-CapabilityNTN-Mode-r17) may be used to indicate support and/or an IoT status for the per-UE capabilities for an NTN. Many, or all, of the information elements of the per-UE capability information for a TN field may be duplicated for the per-UE capability information for an NTN field. Thus, a size of the UE capability information message 665 may be significant, and reduction of the size of the UE capability information message 665 may be needed to reduce overhead.

The UE 120 may perform selective reporting of per-band capabilities (e.g., for an NTN and/or a TN) according to a band filtering indication, in which the base station 110 provides an indication of the bands or band combinations (e.g., in the UE capability request message) for which the UE 120 is to report UE capability information. For example, separate band numbers may be defined for NTN bands and TN bands, thereby facilitating indication of NTN and/or TN bands or band combinations in the band filtering indication. In this way, the size of the UE capability information message may be reduced.

However, a similar filtering indication does not exist for per-UE capability reporting. Moreover, the UE 120 may have different per-UE capabilities and/or IoT statuses for an NTN and a TN. Thus, the UE 120 may need to separately report such different capabilities (e.g., the UE 120 cannot report a single set of capabilities that are applicable to both an NTN and a TN). Reporting per-UE capabilities for both an NTN and a TN in a case when the base station 110 needs UE capability information for only one of an NTN or a TN results in significant overhead and consumes excessive network resources. Similarly, reporting per-UE capabilities for only one of an NTN or a TN in a case when the base station 110 needs UE capability information for both an NTN and a TN is incomplete and may result in multiple requests for UE capability information and/or improper configuration of the UE 120. Similar circumstances may arise in connection with reporting UE capability information for licensed spectrum and unlicensed spectrum (e.g., the UE 120 may have different per-UE capabilities for licensed spectrum and unlicensed spectrum, and therefore separate reporting of such different capabilities is needed).

Some techniques and apparatuses described herein provide for selective reporting of UE capability information, and in particular, selective reporting of per-UE capabilities (e.g., band-independent capabilities) of the UE capability information. For example, in a case when the base station 110 could utilize UE capability information for one of an NTN or a TN, the UE 120 may likewise report UE capability information for the one of an NTN or a TN. Accordingly, overhead associated with reporting UE capability information for both an NTN and a TN in such a case is reduced. As another example, in a case when the base station 110 could utilize UE capability information for both an NTN and a TN, the UE 120 may likewise report UE capability information for both an NTN and a TN. Accordingly, multiple requests for UE capability information and/or improper configuration of the UE 120, which may result from reporting UE capability information for one of an NTN or a TN in such a case, may be avoided.

In some aspects, a UE may receive an explicit indication from a base station of whether the UE is to report UE capability information for an NTN, a TN, or both an NTN and a TN. In some aspects, a UE may determine whether the UE is to report UE capability information for an NTN, a TN, or both an NTN and a TN based at least in part on network information (e.g., which may indicate that the UE is in a coverage of an NTN and/or a TN) and/or UE information (e.g., which may indicate parameters indicating whether communication using an NTN and/or a TN is likely for the UE). In a similar manner, the UE 120 may selectively report UE capability information for one of licensed spectrum or unlicensed spectrum or both licensed spectrum and unlicensed spectrum.

As indicated above, FIGS. 6A-6B are provided as examples. Other examples may differ from what is described with regard to FIGS. 6A-6B.

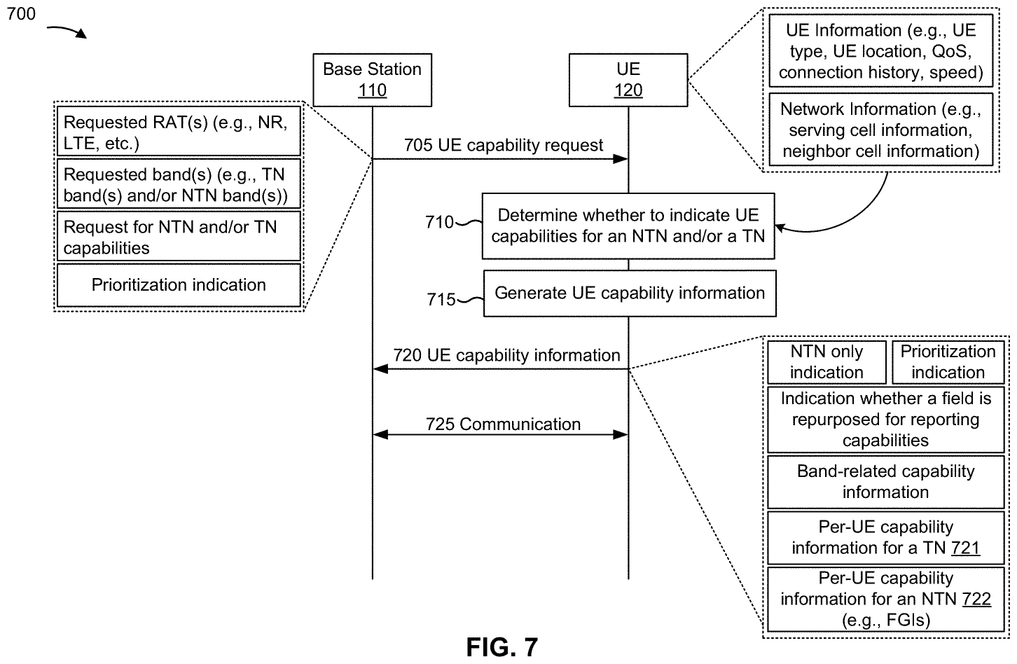

FIG. 7 is a diagram illustrating an example 700 associated with selective reporting of UE capability information, in accordance with the present disclosure. As shown in FIG. 7, a base station 110 and a UE 120 may communicate with one another.

As shown by reference number 705, the base station 110 may transmit, and the UE 120 may receive, a UE capability request message (e.g., a request for UE capability information from the UE 120, which may also be referred to as a “UE capability enquiry”). In some aspects, the UE 120 may determine which capabilities of the UE 120 are to be reported to the base station 110 based at least in part on explicit signaling from the base station 110.

In some aspects, the base station 110 may transmit, and the UE 120 may receive, a first indication (e.g., signaling) that the UE 120 is to indicate UE capabilities associated with a particular one of an NTN (e.g., only an NTN), a TN (e.g., only a TN), or both an NTN and a TN (e.g., the first indication is a per-UE capability filter) in a UE capability information message. For example, the first indication may be in the UE capability request message (e.g., transmission/reception of the UE capability request message and the first indication is the same transmission/reception). As another example, the first indication may be in another (e.g., existing) message or signaling from the base station 110 to the UE 120, such as an RRC connection release message or an RRC reconfiguration message. Here, the first indication may indicate the UE capabilities that are to be reported by the UE 120 in a subsequent capability reporting. In some aspects, the first indication may use signaling in any layer, such as Layer 1 (L1), MAC, RLC, PDCP, SDAP, RRC, and/or non-access stratum (NAS). In some aspects, the first indication may indicate a request for the UE 120 to report (or not report) per-UE capability information for an NTN and/or a TN. In some aspects, the first indication may indicate a request for the UE 120 to report (or not report) all capability information (e.g., per-UE capability information and per-band capability information) for an NTN and/or a TN. Here, the UE 120 may report UE capability information in accordance with the first indication regardless of any request for band reporting (e.g., in band request signaling) that is to the contrary.

In some aspects, the base station 110 may transmit, and the UE 120 may receive, a second indication (e.g., signaling) of one or more bands or band combinations for which a UE capability information message is to indicate per-band capabilities of the UE 120. That is, the second indication may be a band filtering indication, as described herein. For example, the second indication may be in the UE capability request message (e.g., transmission/reception of the UE capability request and the second indication is the same transmission/reception). Based at least in part on the one or more bands or band combinations of the second indication, the UE 120 may determine whether to report UE capabilities associated with an NTN and/or a TN, as NTN bands may have separate band numbers from TN bands (e.g., an NTN band may have a specified NTN band number or NTN bands may be associated with band numbers in a specified range, such as 400-499). For example, the UE 120 may report UE capabilities associated with an NTN if the one or more bands or band combinations include an NTN band and/or the UE 120 may report UE capabilities associated with a TN if the one or more bands or band combinations include a TN band. In other words, if the one or more bands or band combinations includes an NTN band, then the UE 120 may report UE capabilities for an NTN; otherwise, the UE 120 may refrain from reporting UE capabilities for an NTN.

In some aspects, the UE 120 may not receive the first indication or the second indication from the base station 110. Here, the UE 120 may follow a default behavior for reporting UE capability information. For example, the UE 120 may report UE capabilities for an NTN (as well as UE capabilities for a TN if reporting of both is supported), or the UE 120 may report UE capabilities for only a TN. In some aspects, if the UE 120 does not receive the first indication or the second indication from the base station 110, the UE 120 may use implicit detection, as described herein, to determine whether to report UE capabilities for an NTN and/or a TN.

As shown by reference number 710, the UE 120 may determine whether the UE capability information to be reported by the UE 120 is to indicate UE capabilities associated with an NTN and/or a TN (which is also referred to herein as “implicit detection”).

In some aspects, the UE 120 may perform the implicit detection based at least in part on network information. That is, the UE 120 may determine, based at least in part on the network information, whether the UE 120 is to indicate UE capabilities associated with a particular one of an NTN, a TN, or both an NTN and a TN in a UE capability information message. For example, the UE 120 may detect, based at least in part on the network information, whether the UE 120 is in a coverage of an NTN, a coverage of a TN, or a coverage of both an NTN and a TN. The network information may include serving cell information indicating whether a serving cell for the UE 120 is operated in an NTN or a TN and/or neighboring cell information indicating whether a neighboring cell (e.g., which may or may not overlap with the serving cell) for the UE 120 is operated in an NTN or a TN. The UE 120 may receive the network information from the base station 110 in a master information block (MIB), a system information block (SIB), and/or in dedicated signaling for the UE 120 (e.g., RRC signaling).

In some aspects, the UE 120 may perform the implicit detection using UE information. That is, the UE 120 may determine, based at least in part on the UE information, whether the UE is to indicate the one or more UE capabilities associated with a particular one of the NTN, the TN, or both the NTN and the TN in a UE capability information message. The UE information may include a type of the UE 120, which may indicate whether the UE 120 is an NTN only UE, or the like. The UE information may include a location of the UE 120. For example, using operator area information (e.g., from an application layer of the UE 120 or from the base station 110) and based at least in part on the location of the UE 120, the UE 120 may determine whether an NTN and/or a TN are deployed for the location of the UE 120. The operator area information may be map-based or tracking area-based. The operator area information may be updated for the UE 120 periodically or by a triggering event (e.g., movement of the UE 120). The UE information may include a quality of service (QoS) for communications of the UE 120 (e.g., a QoS that the UE 120 can provide). For example, the UE 120 may determine to report UE capabilities for a TN if the QoS requires relatively higher (e.g., satisfies a threshold) performance; otherwise, the UE 120 may determine to report UE capabilities for only an NTN. The QoS may be indicated by a QoS class identifier (QCI), 5G QoS indicator (5QI), a data rate (e.g., per UE, per QoS, QCI, and/or 5QI, per radio bearer, per logical channel, per MAC entity, per L1 processing, or the like), a latency (e.g., a packet delay budget (PDB), a round-trip time (RTT) (in RLC or hybrid automatic repeat request (HARQ)), or a one-way delay), a resource type (e.g., a guaranteed bit rate (GBR) type or a non-GBR type), a priority level, a packet error rate (e.g., expressed as a percentage over a time span), a maximum data burst volume, a data rate averaging window, a particular service (e.g., a voice service, a video call service, a delay tolerant service, a V2X service, a short message service (SMS), or the like), a codec or rate-related information (e.g., an adaptive multi-rate wideband (AMR-WB) codec, an enhanced voice services (EVS) codec, a low-rate voice (e.g., less than 12 kilobytes per second) compression mechanism, or the like), a quantity of bearers, and/or a quantity of logical channels, among other examples. The UE information may include a connection history of the UE 120 (e.g., one or more previous connections of the UE 120). For example, the UE 120 may determine to report UE capabilities for an NTN if a previous connection (e.g., an immediately preceding connection, or a connection within a threshold time window) was to an NTN (e.g., as this may indicate that the UE 120 is in an NTN coverage area). The UE information may include a speed of movement of the UE 120. For example, the UE 120 may determine to report UE capabilities for an NTN if the speed of the UE 120 satisfies a threshold (e.g., as this may indicate that the UE 120 is on an airplane).

In some aspects, the UE 120 may store the network information and/or the UE information (e.g., for use in performing implicit detection). In some aspects, the UE 120 may use the network information and/or the UE information for performing implicit detection (e.g., the network information and/or the UE information is valid) only if the information is fresh (e.g., the network information and/or the UE information is not older than a threshold age). In some aspects, the UE 120 may be unable to detect whether the UE capability information to be reported by the UE 120 is to include capabilities for an NTN and/or a TN using the network information and/or the UE information. Here, the UE 120 may follow the default behavior for reporting UE capability information, as described herein.

As shown by reference number 715, the UE 120 may generate UE capability information that indicates UE capabilities (e.g., per-UE capabilities) of the UE 120. For example, the UE 120 may selectively generate UE capability information for an NTN, a TN, or both an NTN and a TN. The UE 120 may selectively generate the UE capability information based at least in part on a determination of whether the UE 120 is to report UE capabilities for an NTN and/or a TN. For example, the UE 120 may selectively generate the UE capability information using the first indication, the second indication, and/or the implicit detection.

As shown by reference number 720, the UE 120 may transmit, and the base station 110 may receive, a UE capability information message. For example, the UE 120 may transmit the UE capability information message in response to the UE capability request message. The UE capability information message may selectively indicate UE capabilities (e.g., per-UE capabilities) associated with one of an NTN, a TN, or both an NTN and a TN. That is, the UE capability information message may indicate UE capabilities of the UE 120 based at least in part on the first indication, the second indication, and/or the implicit detection.

For example, the UE capability information message may indicate the UE capabilities for an NTN, a TN, or both an NTN and a TN in accordance with the first indication. As another example, the UE capability information message may indicate the UE capabilities for an NTN if the one or more bands or band combinations of the second indication include an NTN band, and/or the UE capability information message may indicate the UE capabilities for a TN if the one or more bands or band combinations of the second information include a TN band. As a further example, the UE capability information message may indicate the UE capabilities for an NTN, a TN, or both an NTN and a TN based at least in part on determining, using the network information or the UE information, that the UE capability information message is to indicate the UE capabilities for a particular one of an NTN, a TN, or both an NTN and a TN. For example, the UE capability information message may indicate, based at least in part on the network information, the UE capabilities for one of an NTN, a TN, or both an NTN and a TN.

In some aspects, the UE capability information message may indicate the UE capabilities for an NTN (though some per-UE capabilities for a TN are mandated for reporting and may not be entirely omitted). In some aspects, the UE capability information message may indicate the UE capabilities for an NTN in a field 721 of the UE capability information message designated for capability indication for a TN (e.g., a per-UE capability field for a TN). That is, the UE 120 may re-purpose the field 721 for capability indication for a TN for reporting UE capabilities for an NTN. Thus, the base station 110 may re-interpret the field 721 for capability indication for a TN as indicating UE capabilities for an NTN. In some aspects, the UE capability information message may include an indication that the UE capabilities for an NTN are in the field 721 designated for capability indication for a TN (e.g., an indication that the field 721 designated for UE capability indication for a TN has been repurposed for indicating UE capabilities for an NTN).

In some aspects, the UE 120 may transmit an indication to the base station 110 indicating that the UE 120 does not repurpose the field 721 designated for capability indication for a TN when reporting UE capability information. In some aspects, the base station 110 may transmit an indication to the UE 120 indicating whether the base station 110 supports the field 721 designated for capability indication for a TN being repurposed. In some aspects, the base station 110 may transmit an indication to the UE 120 indicating that the UE 120 is to report UE capability information by repurposing the field 721 designated for capability indication for a TN. If the UE 120 or the base station 110 does not support the field 721 designated for capability indication for a TN being repurposed, then the UE capability information message may indicate the UE capabilities for an NTN in a first field 722 of the UE capability information message designated for capability indication for an NTN (e.g., a per-UE capability field for an NTN). Moreover, the UE capability information message may indicate, in a second field 721 of the UE capability information message designated for capability indication for a TN, that all features for the second field 721 (e.g., all UE capabilities reported in the second field) are not supported (or that the UE 120 has an IoT status).

In some aspects, the UE capability information message may indicate UE capabilities for a TN in a field 722 designated for an NTN. In some aspects, the UE capability information may indicate UE capabilities for a TN in a first field 721 designated for a TN, and the UE capability information message may indicate, in a second field 722 of the UE capability information message designated for an NTN, that all features for the second field 722 are not supported.

In some aspects, the UE capability information generated by the UE 120 may have a size that is greater than a protocol data unit (PDU) size (e.g., an RRC PDU size, a PDCP PDU size, or a transport block size, among other examples), and therefore the UE capability information cannot be accommodated by a PDU. This could result in the UE capability information reported by the UE 120 being incomplete, such that the base station 110 may trigger the UE 120 to transmit UE capability information multiple times until all of the UE capability information is reported. However, in some aspects, the UE capability information message transmitted by the UE 120 may prioritize indicating the UE capabilities (e.g., per-UE capabilities and/or per-band capabilities) for one of an NTN or a TN over indicating the UE capabilities for the other of the NTN or the TN. For example, the UE capability information message may prioritize indicating UE capabilities for an NTN over indicating UE capabilities for a TN (e.g., the UE capabilities for a TN may be dropped from the UE capability information message or shortened to make space for reporting the UE capabilities for an NTN). In some aspects, the UE capability information message transmitted by the UE 120 may prioritize per-band capabilities for particular bands or band combinations requested by the base station 110 for prioritization.

The UE 120 may determine whether to prioritize reporting UE capabilities for an NTN or a TN based at least in part on information, such as an explicit indication (in a similar manner as the first indication or the second indication, described above) and/or network information and/or UE information using implicit detection (in a similar manner as described above).

In some aspects, the base station 110 may transmit, and the UE 120 may receive, an indication that the UE is to prioritize indicating the UE capabilities for one of the NTN or the TN. For example, the indication may be in the UE capability request message. In some aspects, the indication may be an explicit indication that the UE 120 is to prioritize indicating the UE capabilities for one of an NTN or a TN. In some aspects, the indication may be the first indication described above. For example, if the indication indicates that the UE 120 is to indicate UE capabilities for an NTN, then the UE 120 may prioritize indicating UE capabilities for an NTN over a TN. In some aspects, the indication may be the second indication described above. For example, if the indication indicates one or more bands or band combinations that include an NTN band, then the UE 120 may prioritize indicating UE capabilities for an NTN over a TN.

In some aspects, the UE 120 may perform the implicit detection, in a similar manner as described above, to determine whether to prioritize indicating UE capabilities for an NTN or a TN. The UE 120 may perform the implicit detection using network information and/or UE information, in a similar manner as described above. For example, if the UE 120 detects, using the network information, that the UE 120 is in a coverage of an NTN, then the UE 120 may prioritize indicating UE capabilities for an NTN over a TN.

In some aspects, the UE 120 may always prioritize indicating UE capabilities for a particular one of an NTN or a TN (e.g., according to a configuration for the UE 120 or other information stored by the UE 120). For example, the UE 120 may always prioritize indicating UE capabilities for an NTN, as an NTN has greater coverage than a TN.

The UE 120 may apply the prioritization to any UE capability reporting. For example, the UE 120 may apply the prioritization to per-band capabilities (e.g., prioritize indicating per-band capabilities for NTN bands over TN bands) and/or to per-UE capabilities (e.g., prioritize indicating per-UE capabilities for an NTN over a TN). In some aspects, the UE capability information message (or another message) may include an indication that the UE capability information message prioritizes indicating the UE capabilities for one of the NTN or the TN. That is, the indication may indicate whether prioritization was used for the UE capability information message and/or which of an NTN or a TN was prioritized.

In some aspects, the base station 110 may request the UE 120 to apply multiple prioritization rules. For example, the base station 110 may request that the UE 120 prioritize per-band capabilities for particular bands or band combinations and the base station 110 may also request that the UE 120 prioritize reporting for an NTN or a TN. Here (e.g., if the multiple requests are inconsistent), the UE 120 may apply the request that the UE 120 prioritize reporting for an NTN or a TN (e.g., and ignore the request that the UE 120 prioritize per-band capabilities for particular bands or band combinations). Otherwise, the base station 110 may ensure that multiple prioritization requests are consistent with each other.

In some aspects, a type of the UE 120 is NTN only (i.e., the UE is an NTN only UE), where the UE 120 supports only NTN access (which may be referred to as an “NTN only UE” or a “dish-type UE”). Here, the UE 120 may be in a fixed location and may not support mobility (e.g., for handover to a TN). If the UE 120 is an NTN only UE, then the UE 120 may ignore (e.g., discard) a request from the base station 110 to report capabilities of the UE 120 for particular TN bands and/or ignore a request from the base station 110 to report capabilities (e.g., per-UE capabilities) of the UE 120 for a TN. For example, the UE 120 may report capabilities for only NTN bands. Moreover, if the UE 120 is an NTN only UE, then the UE 120 may ignore (e.g., discard) a rule (e.g., an extension defined for NR UEs) to signal TN capabilities differently for an NTN. For example, the UE capability information message may indicate per-band capabilities (e.g., feature sets) for only NTN bands and indicate per-UE capabilities for only an NTN (e.g., the per-UE capability reporting applies only to an NTN and not a TN). Thus, the entirety of a container for the UE capability information message (e.g., the entirety of the UE capability information) relates to only an NTN. In some aspects, the UE capability information message (or another message) may include an indication that the type of the UE is NTN only (i.e., that the UE is an NTN only UE) or that the UE capability information message is for only an NTN (e.g., that the entirety of the container for the UE capability information message relates to only an NTN).

In some aspects, the UE capability information message may indicate the capabilities of the UE 120 using one or more feature group indications (FGIs). For example, the per-UE capabilities for an NTN may be defined as one or more feature groups, and the UE 120 may indicate support (e.g., capability or IoT status) for a feature group using a bit of the UE capability information message, thereby reducing overhead. A feature group may include multiple related features associated with UE capabilities, and the UE 120 may indicate a capability for the multiple features of the feature group using a single FGI (rather than separately indicating capabilities for the multiple features). As described herein, the UE capability information message may indicate per-band capabilities of the UE 120 and/or per-UE capabilities of the UE 120. The per-band capabilities may indicate band information, such one or more band numbers. The per-UE capabilities may indicate whether the UE 120 supports an RRC inactive state, whether the UE 120 supports a 2-step random-access channel (RACH) procedure, and/or a measurement capability of the UE 120, among other examples.

As shown by reference number 725, the UE 120 and the base station 110 may communicate. For example, the base station 110 may transmit one or more downlink communications to the UE 120 and/or the UE 120 may transmit one or more uplink communications to the base station 110. The UE 120 and the base station 110 may communicate in accordance with the UE capabilities reported by the UE 120 in the UE capability information message. For example, the base station 110 may configure the UE 120 (e.g., by transmitting an RRC configuration to the UE 120) for communication with the base station 110 in accordance with the capabilities of the UE 120 indicated by the UE capability information message.

As indicated above, FIG. 7 is provided as an example. Other examples may differ from what is described with respect to FIG. 7.

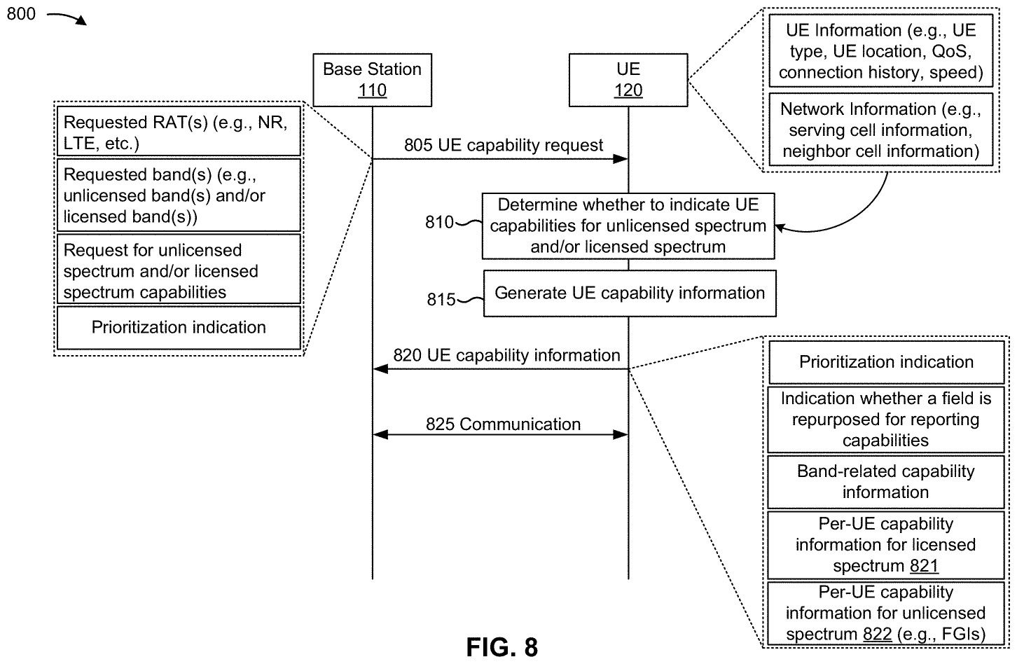

FIG. 8 is a diagram illustrating an example 800 associated with selective reporting of UE capability information, in accordance with the present disclosure. As shown in FIG. 8, a base station 110 and a UE 120 may communicate with one another.

As shown by reference number 805, the base station 110 may transmit, and the UE 120 may receive, a UE capability request message, as described herein. In some aspects, the UE 120 may determine which capabilities of the UE 120 are to be reported to the base station 110 based at least in part on explicit signaling from the base station 110.

In some aspects, the base station 110 may transmit, and the UE 120 may receive, a first indication (e.g., signaling) that the UE 120 is to indicate UE capabilities associated with (e.g., for communication by the UE in) a particular one of unlicensed spectrum (e.g., only unlicensed spectrum), licensed spectrum (e.g., only licensed spectrum), or both unlicensed and licensed spectrum (e.g., the first indication is a per-UE capability filter) in a UE capability information message, in a similar manner as described herein.

In some aspects, the base station 110 may transmit, and the UE 120 may receive, a second indication (e.g., signaling) of one or more bands or band combinations for which a UE capability information message is to indicate per-band capabilities of the UE 120, in a similar manner as described herein. Based at least in part on the one or more bands or band combinations of the second indication, the UE 120 may determine whether to report UE capabilities associated with unlicensed spectrum and/or licensed spectrum, in a similar manner as described herein. For example, the UE 120 may report UE capabilities associated with unlicensed spectrum if the one or more bands or band combinations include an unlicensed frequency band and/or the UE 120 may report UE capabilities associated with licensed spectrum if the one or more bands or band combinations include a licensed frequency band.

In some aspects, the UE 120 may not receive the first indication or the second indication from the base station 110. Here, the UE 120 may follow a default behavior for reporting UE capability information, as described herein. In some aspects, if the UE 120 does not receive the first indication or the second indication from the base station 110, the UE 120 may use implicit detection, as described herein, to determine whether to report UE capabilities for unlicensed spectrum and/or licensed spectrum.

As shown by reference number 810, the UE 120 may determine whether the UE capability information to be reported by the UE 120 is to indicate UE capabilities associated with unlicensed spectrum and/or licensed spectrum, in a similar manner as described herein.

In some aspects, the UE 120 may perform the implicit detection based at least in part on network information. That is, the UE 120 may determine, based at least in part on the network information, whether the UE 120 is to indicate UE capabilities associated with a particular one of unlicensed spectrum, licensed spectrum, or both unlicensed and licensed spectrum in a UE capability information message, in a similar manner as described herein.

In some aspects, the UE 120 may perform the implicit detection using UE information. That is, the UE 120 may determine, based at least in part on the UE information, whether the UE is to indicate the one or more UE capabilities associated with a particular one of unlicensed spectrum, licensed spectrum, or both unlicensed and licensed spectrum in a UE capability information message, in a similar manner as described herein.

As shown by reference number 815, the UE 120 may generate UE capability information that indicates UE capabilities (e.g., per-UE capabilities) of the UE 120. For example, the UE 120 may selectively generate UE capability information for unlicensed spectrum, licensed spectrum, or both unlicensed and licensed spectrum. The UE 120 may selectively generate the UE capability information based at least in part on a determination of whether the UE 120 is to report UE capabilities for unlicensed spectrum and/or licensed spectrum. For example, the UE 120 may selectively generate the UE capability information using the first indication, the second indication, and/or the implicit detection.

As shown by reference number 820, the UE 120 may transmit, and the base station 110 may receive, a UE capability information message. For example, the UE 120 may transmit the UE capability information message in response to the UE capability request message. The UE capability information message may selectively indicate UE capabilities (e.g., per-UE capabilities) associated with one of unlicensed spectrum, licensed spectrum, or both unlicensed and licensed spectrum. That is, the UE capability information message may indicate UE capabilities of the UE 120 based at least in part on the first indication, the second indication, and/or the implicit detection.

For example, the UE capability information message may indicate the UE capabilities for unlicensed spectrum, licensed spectrum, or both unlicensed and licensed spectrum in accordance with the first indication. As another example, the UE capability information message may indicate the UE capabilities for unlicensed spectrum if the one or more bands or band combinations of the second indication include an unlicensed frequency band, and/or the UE capability information message may indicate the UE capabilities for licensed spectrum if the one or more bands or band combinations of the second information include a licensed frequency band. As a further example, the UE capability information message may indicate the UE capabilities for unlicensed spectrum, licensed spectrum, or both unlicensed and licensed spectrum based at least in part on determining, using the network information or the UE information, that the UE capability information message is to indicate the UE capabilities for a particular one of unlicensed spectrum, licensed spectrum, or both unlicensed and licensed spectrum.

In some aspects, the UE capability information message may indicate the UE capabilities for unlicensed spectrum. In some aspects, the UE capability information message may indicate the UE capabilities for unlicensed spectrum in a field 821 of the UE capability information message designated for licensed spectrum, in a similar manner as described herein. In some aspects, the UE capability information message may include an indication that the UE capabilities for unlicensed spectrum are in the field 821 designated for licensed spectrum.

If the UE 120 or the base station 110 does not support the field 821 designated for capability indication for licensed spectrum being repurposed, as described herein, then the UE capability information message may indicate the UE capabilities for unlicensed spectrum in a first field 822 of the UE capability information message designated for capability indication for unlicensed spectrum. Moreover, the UE capability information message may indicate, in a second field 821 of the UE capability information message designated for capability indication for licensed spectrum, that all features for the second field 821 (e.g., all UE capabilities reported in the second field) are not supported (or that the UE 120 has an IoT status).

In some aspects, the UE capability information message may indicate UE capabilities for licensed spectrum in a field 822 designated for unlicensed spectrum. In some aspects, the UE capability information may indicate UE capabilities for licensed spectrum in a first field 821 designated for licensed spectrum, and the UE capability information message may indicate, in a second field 822 of the UE capability information message designated for unlicensed spectrum, that all features for the second field 822 are not supported.

In some aspects, the UE capability information generated by the UE 120 may have a size that is greater than a PDU size, in a similar manner as described herein. In some aspects, the UE capability information message transmitted by the UE 120 may prioritize indicating the UE capabilities (e.g., per-UE capabilities and/or per-band capabilities) for one of unlicensed spectrum or licensed spectrum over indicating the UE capabilities for the other of unlicensed spectrum or licensed spectrum, in a similar manner as described herein.

The UE 120 may determine whether to prioritize reporting UE capabilities for unlicensed spectrum or licensed spectrum based at least in part on information, such as an explicit indication and/or network information and/or UE information using implicit detection, in a similar manner as described herein.

In some aspects, the UE 120 may always prioritize indicating UE capabilities for a particular one of unlicensed spectrum or licensed spectrum, in a similar manner as described herein.

The UE 120 may apply the prioritization to any UE capability reporting. For example, the UE 120 may apply the prioritization to per-band capabilities and/or to per-UE capabilities, in a similar manner as described herein. In some aspects, the UE capability information message (or another message) may include an indication that the UE capability information message prioritizes indicating the UE capabilities for one of unlicensed spectrum or licensed spectrum, in a similar manner as described herein.

In some aspects, the base station 110 may request the UE 120 to apply multiple prioritization rules. For example, the base station 110 may request that the UE 120 prioritize per-band capabilities for particular bands or band combinations and the base station 110 may also request that the UE 120 prioritize reporting for unlicensed spectrum or licensed spectrum. Here (e.g., if the multiple requests are inconsistent), the UE 120 may apply the request that the UE 120 prioritize reporting for unlicensed spectrum or licensed spectrum (e.g., and ignore the request that the UE 120 prioritize per-band capabilities for particular bands or band combinations). Otherwise, the base station 110 may ensure that multiple prioritization requests are consistent with each other.

In some aspects, the UE capability information message may indicate the capabilities of the UE 120 using one or more feature group indications (FGIs), in a similar manner as described herein. As described herein, the UE capability information message may indicate per-band capabilities of the UE 120 and/or per-UE capabilities of the UE 120. The per-band capabilities may indicate band information, such as one or more band numbers. The per-UE capabilities may indicate whether the UE 120 supports an RRC inactive state, whether the UE 120 supports a 2-step random-access channel (RACH) procedure, and/or a measurement capability of the UE 120, among other examples.

As shown by reference number 825, the UE 120 and the base station 110 may communicate. For example, the base station 110 may transmit one or more downlink communications to the UE 120 and/or the UE 120 may transmit one or more uplink communications to the base station 110. The UE 120 and the base station 110 may communicate in accordance with the UE capabilities reported by the UE 120 in the UE capability information message. For example, the base station 110 may configure the UE 120 (e.g., by transmitting an RRC configuration to the UE 120) for communication with the base station 110 in accordance with the capabilities of the UE 120 indicated by the UE capability information message.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with selective reporting of UE capability information.

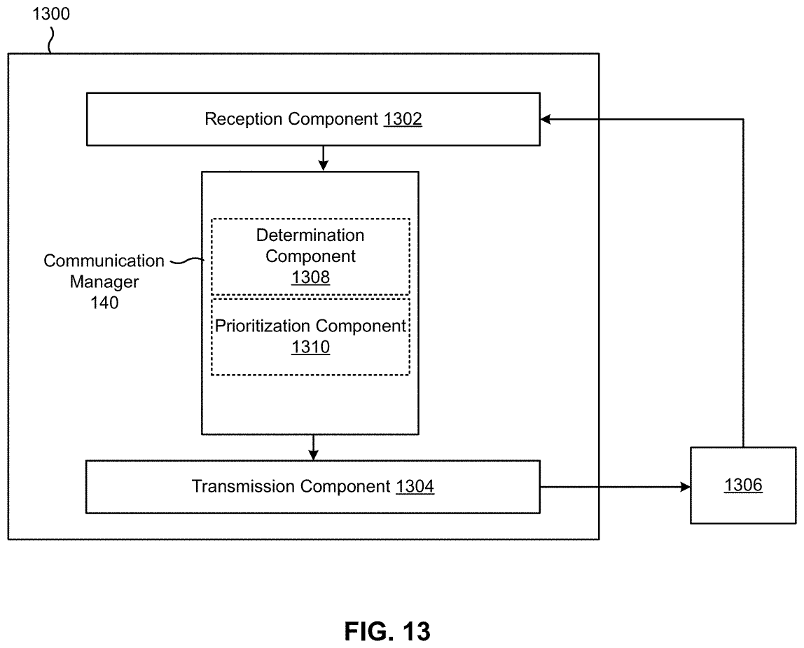

As shown in FIG. 9, in some aspects, process 900 may include receiving, from a base station, a UE capability request message (block 910). For example, the UE (e.g., using communication manager 140 and/or reception component 1302, depicted in FIG. 13) may receive, from a base station, a UE capability request message, as described above. In some aspects, process 900 may include receiving an indication that one or more UE capabilities associated with a particular one of an NTN, a TN, or both the NTN and the TN are to be indicated in a UE capability information message (block 912). For example, the UE (e.g., using communication manager 140 and/or reception component 1302, depicted in FIG. 13) may receive an indication that one or more UE capabilities associated with a particular one of an NTN, a TN, or both the NTN and the TN are to be indicated in a UE capability information message, as described above. In some aspects, process 900 may include receiving an indication of one or more bands or band combinations (block 914). For example, the UE (e.g., using communication manager 140 and/or reception component 1302, depicted in FIG. 13) may receive an indication one or more bands or band combinations, as described above.

In some aspects, process 900 may include determining based at least in part on network information and/or UE information that the UE is to indicate the one or more UE capabilities associated with a particular one of the NTN, the TN, or both the NTN and the TN in the UE capability information message (block 916). For example, the UE (e.g., using communication manager 140 and/or determination component 1308, depicted in FIG. 13) may determine based at least in part on network information and/or UE information that the UE is to indicate the one or more UE capabilities associated with a particular one of the NTN, the TN, or both the NTN and the TN in the UE capability information message, as described above.

As further shown in FIG. 9, in some aspects, process 900 may include transmitting, to the base station in response to the UE capability request message, the UE capability information message that indicates one or more UE capabilities associated with one of the NTN, the TN, or both the NTN and the TN (block 920). For example, the UE (e.g., using communication manager 140 and/or transmission component 1304, depicted in FIG. 13) may transmit, to the base station in response to the UE capability request message, the UE capability information message that indicates one or more UE capabilities associated with one of the NTN, the TN, or both the NTN and the TN, as described above.

Process 900 may include additional aspects, such as any single aspect or any combination of aspects described below and/or in connection with one or more other processes described elsewhere herein.

In a first aspect, process 900 includes receiving (e.g., using communication manager 140 and/or reception component 1302, depicted in FIG. 13), from the base station, an indication that the one or more UE capabilities associated with a particular one of the NTN, the TN, or both the NTN and the TN are to be indicated in the UE capability information message, where the UE capability information message indicates the one or more UE capabilities in accordance with the indication.

In a second aspect, alone or in combination with the first aspect, process 900 includes receiving (e.g., using communication manager 140 and/or reception component 1302, depicted in FIG. 13), from the base station, an indication of one or more bands or band combinations for which the UE capability information message is to indicate per-band UE capabilities, where the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

In a third aspect, alone or in combination with one or more of the first and second aspects, process 900 includes determining (e.g., using communication manager 140 and/or determination component 1308, depicted in FIG. 13) based at least in part on network information that the UE is to indicate the one or more UE capabilities associated with a particular one of the NTN, the TN, or both the NTN and the TN in the UE capability information message, where the UE capability information message indicates the one or more UE capabilities associated with the particular one of the NTN, the TN, or both the NTN and the TN.

In a fourth aspect, alone or in combination with one or more of the first through third aspects, the network information includes at least one of serving cell information indicating that a serving cell for the UE is operated in the NTN or the TN, or neighboring cell information indicating that a neighboring cell for the UE is operated in the NTN or the TN.

In a fifth aspect, alone or in combination with one or more of the first through fourth aspects, process 900 includes determining (e.g., using communication manager 140 and/or determination component 1308, depicted in FIG. 13) based at least in part on UE information that the UE is to indicate the one or more UE capabilities associated with a particular one of the NTN, the TN, or both the NTN and the TN in the UE capability information message, where the UE capability information message indicates the one or more UE capabilities for the particular one of the NTN, the TN, or both the NTN and the TN.

In a sixth aspect, alone or in combination with one or more of the first through fifth aspects, the UE information includes at least one of a type of the UE, a location of the UE, a quality of service for communications of the UE, a connection history of the UE, or a speed of movement of the UE.

In a seventh aspect, alone or in combination with one or more of the first through sixth aspects, the UE capability information message indicates the one or more UE capabilities associated with the NTN in a field of the UE capability information message designated for capability indication for the TN.

In an eighth aspect, alone or in combination with one or more of the first through seventh aspects, the UE capability information message includes an indication that the one or more UE capabilities associated with the NTN are in the field of the UE capability information message designated for capability indication for the TN.

In a ninth aspect, alone or in combination with one or more of the first through eighth aspects, the UE capability information message indicates the one or more UE capabilities associated with the NTN in a field of the UE capability information message designated for capability indication for the NTN.

In a tenth aspect, alone or in combination with one or more of the first through ninth aspects, the UE capability information message indicates, in an additional field of the UE capability information message designated for capability indication for the TN, that all features for the additional field lack support.

In an eleventh aspect, alone or in combination with one or more of the first through tenth aspects, the UE capability information message prioritizes indicating the one or more UE capabilities associated with one of the NTN or the TN.

In a twelfth aspect, alone or in combination with one or more of the first through eleventh aspects, process 900 includes receiving (e.g., using communication manager 140 and/or reception component 1302, depicted in FIG. 13), from the base station, an indication that the UE is to prioritize indicating the one or more UE capabilities associated with a particular one of the NTN or the TN in the UE capability information message, where the UE capability information message prioritizes indicating the one or more UE capabilities associated with the particular one of the NTN or the TN.

In a thirteenth aspect, alone or in combination with one or more of the first through twelfth aspects, process 900 includes determining (e.g., using communication manager 140 and/or determination component 1308, depicted in FIG. 13) based at least in part on at least one of network information or UE information that the UE is to prioritize indicating the one or more UE capabilities associated with a particular one of the NTN or the TN in the UE capability information message, where the UE capability information message prioritizes indicating the one or more UE capabilities associated with the particular one of the NTN or the TN.

In a fourteenth aspect, alone or in combination with one or more of the first through thirteenth aspects, the UE capability information message includes an indication that the UE capability information message prioritizes indicating the one or more UE capabilities associated with one of the NTN or the TN.

In a fifteenth aspect, alone or in combination with one or more of the first through fourteenth aspects, the UE is an NTN only UE, and the UE capability information message indicates the one or more UE capabilities associated with only the NTN.

In a sixteenth aspect, alone or in combination with one or more of the first through fifteenth aspects, the UE capability information message includes an indication that the UE is the NTN only UE or that the one or more UE capabilities are associated with only the NTN.

In a seventeenth aspect, alone or in combination with one or more of the first through sixteenth aspects, the UE capability information message indicates the one or more UE capabilities using one or more feature group indications.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with selective reporting of UE capability information.

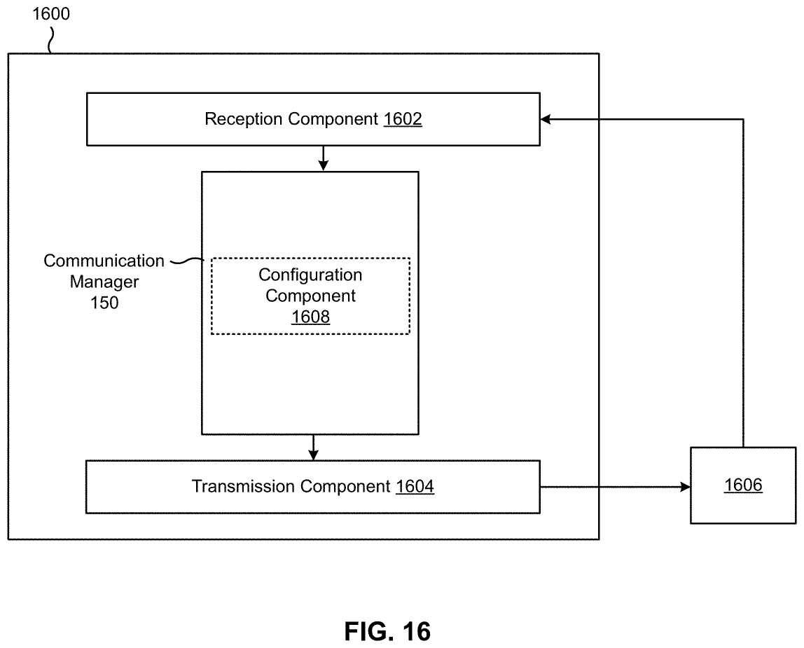

As shown in FIG. 10, in some aspects, process 1000 may include transmitting, to a UE, a UE capability request message (block 1010). For example, the base station (e.g., using communication manager 150 and/or transmission component 1604, depicted in FIG. 16) may transmit, to a UE, a UE capability request message, as described above. In some aspects, process 1000 may include transmitting an indication that one or more UE capabilities associated with a particular one of an NTN, a TN, or both the NTN and the TN are to be indicated in a UE capability information message (block 1012). For example, the base station (e.g., using communication manager 150 and/or transmission component 1604, depicted in FIG. 16) may transmit an indication that one or more UE capabilities associated with a particular one of an NTN, a TN, or both the NTN and the TN are to be indicated in a UE capability information message, as described above. In some aspects, process 1000 may include transmitting an indication of one or more bands or band combinations (block 1014). For example, the base station (e.g., using communication manager 150 and/or transmission component 1604, depicted in FIG. 16) may transmit an indication one or more bands or band combinations, as described above.

As further shown in FIG. 10, in some aspects, process 1000 may include receiving, from the UE in response to the UE capability request message, the UE capability information message that indicates one or more UE capabilities associated with one of the NTN, the TN, or both the NTN and the TN (block 1020). For example, the base station (e.g., using communication manager 150 and/or reception component 1602, depicted in FIG. 16) may receive, from the UE in response to the UE capability request message, the UE capability information message that indicates one or more UE capabilities associated with one of the NTN, the TN, or both the NTN and the TN, as described above.

Process 1000 may include additional aspects, such as any single aspect or any combination of aspects described below and/or in connection with one or more other processes described elsewhere herein.

In a first aspect, process 1000 includes transmitting (e.g., using communication manager 150 and/or transmission component 1604, depicted in FIG. 16), to the UE, an indication that the one or more UE capabilities associated with a particular one of the NTN, the TN, or both the NTN and the TN are to be indicated in the UE capability information message, where the UE capability information message indicates the one or more UE capabilities in accordance with the indication.

In a second aspect, alone or in combination with the first aspect, process 1000 includes transmitting (e.g., using communication manager 150 and/or transmission component 1604, depicted in FIG. 16), to the UE, an indication of one or more bands or band combinations for which the UE capability information message is to indicate per-band UE capabilities, where the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

In a third aspect, alone or in combination with one or more of the first and second aspects, the UE capability information message indicates the one or more UE capabilities associated with the NTN in a field of the UE capability information message designated for capability indication for the TN.

In a fourth aspect, alone or in combination with one or more of the first through third aspects, the UE capability information message includes an indication that the one or more UE capabilities associated with the NTN are in the field of the UE capability information message designated for capability indication for the TN.

In a fifth aspect, alone or in combination with one or more of the first through fourth aspects, the UE capability information message indicates the one or more UE capabilities associated with the NTN in a field of the UE capability information message designated for capability indication for the NTN.

In a sixth aspect, alone or in combination with one or more of the first through fifth aspects, the UE capability information message indicates, in an additional field of the UE capability information message designated for capability indication for the TN, that all features for the additional field lack support.

In a seventh aspect, alone or in combination with one or more of the first through sixth aspects, the UE capability information message prioritizes indicating the one or more UE capabilities associated with one of the NTN or the TN.

In an eighth aspect, alone or in combination with one or more of the first through seventh aspects, process 1000 includes transmitting (e.g., using communication manager 150 and/or transmission component 1604, depicted in FIG. 16), to the UE, an indication that the UE is to prioritize indicating the one or more UE capabilities associated with a particular one of the NTN or the TN in the UE capability information message, where the UE capability information message prioritizes indicating the one or more UE capabilities associated with the particular one of the NTN or the TN.

In a ninth aspect, alone or in combination with one or more of the first through eighth aspects, the UE capability information message includes an indication that the UE capability information message prioritizes indicating the one or more UE capabilities associated with one of the NTN or the TN.

In a tenth aspect, alone or in combination with one or more of the first through ninth aspects, the UE is an NTN only UE, and the UE capability information message indicates the one or more UE capabilities associated with only the NTN.

In an eleventh aspect, alone or in combination with one or more of the first through tenth aspects, the UE capability information message includes an indication that the UE is the NTN only UE or that the one or more UE capabilities are associated with only the NTN.

In a twelfth aspect, alone or in combination with one or more of the first through eleventh aspects, the UE capability information message indicates the one or more UE capabilities using one or more feature group indications.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with selective reporting of UE capability information.

As shown in FIG. 11, in some aspects, process 1100 may include receiving, from a base station, a UE capability request message (block 1110). For example, the UE (e.g., using communication manager 140 and/or reception component 1302, depicted in FIG. 13) may receive, from a base station, a UE capability request message, as described above. In some aspects, process 1100 may include receiving an indication that one or more UE capabilities associated with a particular one of unlicensed spectrum, licensed spectrum, or both unlicensed spectrum and licensed spectrum are to be indicated in a UE capability information message (block 1112). For example, the UE (e.g., using communication manager 140 and/or reception component 1302, depicted in FIG. 13) may receive an indication that one or more UE capabilities associated with a particular one of unlicensed spectrum, licensed spectrum, or both unlicensed spectrum and licensed spectrum are to be indicated in a UE capability information message, as described above. In some aspects, process 1100 may include receiving an indication of one or more bands or band combinations (block 1114). For example, the UE (e.g., using communication manager 140 and/or reception component 1302, depicted in FIG. 13) may receive an indication one or more bands or band combinations, as described above.

In some aspects, process 1100 may include determining based at least in part on network information and/or UE information that the UE is to indicate the one or more UE capabilities associated with a particular one of unlicensed spectrum, licensed spectrum, or both unlicensed spectrum and licensed spectrum in the UE capability information message (block 1116). For example, the UE (e.g., using communication manager 140 and/or determination component 1308, depicted in FIG. 13) may determine based at least in part on network information and/or UE information that the UE is to indicate the one or more UE capabilities associated with a particular one of unlicensed spectrum, licensed spectrum, or both unlicensed spectrum and licensed spectrum in the UE capability information message, as described above.

As further shown in FIG. 11, in some aspects, process 1100 may include transmitting, to the base station in response to the UE capability request message, the UE capability information message that indicates one or more UE capabilities associated with one of unlicensed spectrum, licensed spectrum, or both unlicensed spectrum and licensed spectrum (block 1120). For example, the UE (e.g., using communication manager 140 and/or transmission component 1304, depicted in FIG. 13) may transmit, to the base station in response to the UE capability request message, the UE capability information message that indicates one or more UE capabilities associated with one of unlicensed spectrum, licensed spectrum, or both unlicensed spectrum and licensed spectrum, as described above.

Process 1100 may include additional aspects, such as any single aspect or any combination of aspects described below and/or in connection with one or more other processes described elsewhere herein.

In a first aspect, process 1100 includes receiving (e.g., using communication manager 140 and/or reception component 1302, depicted in FIG. 13), from the base station, an indication that the one or more UE capabilities associated with a particular one of unlicensed spectrum, licensed spectrum, or both unlicensed spectrum and licensed spectrum are to be indicated in the UE capability information message, where the UE capability information message indicates the one or more UE capabilities in accordance with the indication.

In a second aspect, alone or in combination with the first aspect, process 1100 includes receiving (e.g., using communication manager 140 and/or reception component 1302, depicted in FIG. 13), from the base station, an indication of one or more bands or band combinations for which the UE capability information message is to indicate per-band UE capabilities, where the UE capability information message indicates the one or more UE capabilities associated with the unlicensed spectrum in response to the one or more bands or band combinations including an unlicensed band, and the UE capability information message indicates the one or more UE capabilities associated with licensed spectrum in response to the one or more bands or band combinations including a licensed band.

In a third aspect, alone or in combination with one or more of the first and second aspects, process 1100 includes determining (e.g., using communication manager 140 and/or determination component 1308, depicted in FIG. 13) based at least in part on network information that the UE is to indicate the one or more UE capabilities associated with a particular one of unlicensed spectrum, licensed spectrum, or both unlicensed spectrum and licensed spectrum in the UE capability information message, where the UE capability information message indicates the one or more UE capabilities associated with the particular one of unlicensed spectrum, licensed spectrum, or both unlicensed spectrum and licensed spectrum.

In a fourth aspect, alone or in combination with one or more of the first through third aspects, the network information includes at least one of serving cell information indicating that a serving cell for the UE is operated in unlicensed spectrum or licensed spectrum, or neighboring cell information indicating that a neighboring cell for the UE is operated in unlicensed spectrum or licensed spectrum.

In a fifth aspect, alone or in combination with one or more of the first through fourth aspects, process 1100 includes determining (e.g., using communication manager 140 and/or determination component 1308, depicted in FIG. 13) based at least in part on UE information that the UE is to indicate the one or more UE capabilities associated with a particular one of the unlicensed spectrum, licensed spectrum, or both unlicensed spectrum and licensed spectrum in the UE capability information message, where the UE capability information message indicates the one or more UE capabilities for the particular one of unlicensed spectrum, licensed spectrum, or both unlicensed spectrum and licensed spectrum.

In a sixth aspect, alone or in combination with one or more of the first through fifth aspects, the UE information includes at least one of a type of the UE, a location of the UE, a quality of service for communications of the UE, a connection history of the UE, or a speed of movement of the UE.

In a seventh aspect, alone or in combination with one or more of the first through sixth aspects, the UE capability information message indicates the one or more UE capabilities associated with unlicensed spectrum in a field of the UE capability information message designated for capability indication for licensed spectrum.

In an eighth aspect, alone or in combination with one or more of the first through seventh aspects, the UE capability information message includes an indication that the one or more UE capabilities associated with unlicensed spectrum are in the field of the UE capability information message designated for capability indication for licensed spectrum.

In a ninth aspect, alone or in combination with one or more of the first through eighth aspects, the UE capability information message indicates the one or more UE capabilities associated with unlicensed spectrum in a field of the UE capability information message designated for capability indication for unlicensed spectrum.

In a tenth aspect, alone or in combination with one or more of the first through ninth aspects, the UE capability information message indicates, in an additional field of the UE capability information message designated for capability indication for licensed spectrum, that all features for the additional field lack support.

In an eleventh aspect, alone or in combination with one or more of the first through tenth aspects, the UE capability information message prioritizes indicating the one or more UE capabilities associated with one of unlicensed spectrum or licensed spectrum.

In a twelfth aspect, alone or in combination with one or more of the first through eleventh aspects, process 1100 includes receiving (e.g., using communication manager 140 and/or reception component 1302, depicted in FIG. 13), from the base station, an indication that the UE is to prioritize indicating the one or more UE capabilities associated with a particular one of unlicensed spectrum or licensed spectrum in the UE capability information message, where the UE capability information message prioritizes indicating the one or more UE capabilities associated with the particular one of unlicensed spectrum or licensed spectrum.

In a thirteenth aspect, alone or in combination with one or more of the first through twelfth aspects, process 1100 includes determining (e.g., using communication manager 140 and/or determination component 1308, depicted in FIG. 13) based at least in part on at least one of network information or UE information that the UE is to prioritize indicating the one or more UE capabilities associated with a particular one of unlicensed spectrum or licensed spectrum in the UE capability information message, where the UE capability information message prioritizes indicating the one or more UE capabilities associated with the particular one of unlicensed spectrum or licensed spectrum.

In a fourteenth aspect, alone or in combination with one or more of the first through thirteenth aspects, the UE capability information message includes an indication that the UE capability information message prioritizes indicating the one or more UE capabilities associated with one of unlicensed spectrum or licensed spectrum.

In a fifteenth aspect, alone or in combination with one or more of the first through fourteenth aspects, the UE capability information message indicates the one or more UE capabilities using one or more feature group indications.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110) performs operations associated with selective reporting of UE capability information.

As shown in FIG. 12, in some aspects, process 1200 may include transmitting, to a UE, a UE capability request message (block 1210). For example, the base station (e.g., using communication manager 150 and/or transmission component 1604, depicted in FIG. 16) may transmit, to a UE, a UE capability request message, as described above. In some aspects, process 1200 may include transmitting an indication that one or more UE capabilities associated with a particular one of unlicensed spectrum, licensed spectrum, or both unlicensed spectrum and licensed spectrum are to be indicated in a UE capability information message (block 1212). For example, the base station (e.g., using communication manager 150 and/or transmission component 1604, depicted in FIG. 16) may transmit an indication that one or more UE capabilities associated with a particular one of unlicensed spectrum, licensed spectrum, or both unlicensed spectrum and licensed spectrum are to be indicated in a UE capability information message, as described above. In some aspects, process 1200 may include transmitting an indication of one or more bands or band combinations (block 1214). For example, the base station (e.g., using communication manager 150 and/or transmission component 1604, depicted in FIG. 16) may transmit an indication one or more bands or band combinations, as described above.

As further shown in FIG. 12, in some aspects, process 1200 may include receiving, from the UE in response to the UE capability request message, the UE capability information message that indicates one or more UE capabilities associated with one of unlicensed spectrum, licensed spectrum, or both unlicensed spectrum and licensed spectrum (block 1220). For example, the base station (e.g., using communication manager 150 and/or reception component 1602, depicted in FIG. 16) may receive, from the UE in response to the UE capability request message, a UE capability information message that indicates one or more UE capabilities associated with one of unlicensed spectrum, licensed spectrum, or both unlicensed spectrum and licensed spectrum, as described above.

Process 1200 may include additional aspects, such as any single aspect or any combination of aspects described below and/or in connection with one or more other processes described elsewhere herein.

In a first aspect, process 1200 includes transmitting (e.g., using communication manager 150 and/or transmission component 1604, depicted in FIG. 16), to the UE, an indication that the one or more UE capabilities associated with a particular one of unlicensed spectrum, licensed spectrum, or both unlicensed spectrum and licensed spectrum are to be indicated in the UE capability information message, where the UE capability information message indicates the one or more UE capabilities in accordance with the indication.

In a second aspect, alone or in combination with the first aspect, process 1200 includes transmitting (e.g., using communication manager 150 and/or transmission component 1604, depicted in FIG. 16), to the UE, an indication of one or more bands or band combinations for which the UE capability information message is to indicate per-band UE capabilities, where the UE capability information message indicates the one or more UE capabilities associated with the unlicensed spectrum in response to the one or more bands or band combinations including an unlicensed band, and the UE capability information message indicates the one or more UE capabilities associated with licensed spectrum in response to the one or more bands or band combinations including a licensed band.

In a third aspect, alone or in combination with one or more of the first and second aspects, the UE capability information message indicates the one or more UE capabilities associated with unlicensed spectrum in a field of the UE capability information message designated for capability indication for licensed spectrum.

In a fourth aspect, alone or in combination with one or more of the first through third aspects, the UE capability information message includes an indication that the one or more UE capabilities associated with unlicensed spectrum are in the field of the UE capability information message designated for capability indication for licensed spectrum.

In a fifth aspect, alone or in combination with one or more of the first through fourth aspects, the UE capability information message indicates the one or more UE capabilities associated with unlicensed spectrum in a field of the UE capability information message designated for capability indication for unlicensed spectrum.

In a sixth aspect, alone or in combination with one or more of the first through fifth aspects, the UE capability information message indicates, in an additional field of the UE capability information message designated for capability indication for licensed spectrum, that all features for the additional field lack support.

In a seventh aspect, alone or in combination with one or more of the first through sixth aspects, the UE capability information message prioritizes indicating the one or more UE capabilities associated with one of unlicensed spectrum or licensed spectrum.

In an eighth aspect, alone or in combination with one or more of the first through seventh aspects, process 1200 includes transmitting (e.g., using communication manager 150 and/or transmission component 1604, depicted in FIG. 16), to the UE, an indication that the UE is to prioritize indicating the one or more UE capabilities associated with a particular one of unlicensed spectrum or licensed spectrum in the UE capability information message, where the UE capability information message prioritizes indicating the one or more UE capabilities associated with the particular one of unlicensed spectrum or licensed spectrum.

In a ninth aspect, alone or in combination with one or more of the first through eighth aspects, the UE capability information message includes an indication that the UE capability information message prioritizes indicating the one or more UE capabilities associated with one of unlicensed spectrum or licensed spectrum.

In a tenth aspect, alone or in combination with one or more of the first through ninth aspects, the UE capability information message indicates the one or more UE capabilities using one or more feature group indications.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a determination component 1308 or a prioritization component 1310, among other examples.

In some aspects, the apparatus 1300 may be configured to perform one or more operations described herein in connection with FIGS. 7-8. Additionally, or alternatively, the apparatus 1300 may be configured to perform one or more processes described herein, such as process 900 of FIG. 9, process 1100 of FIG. 11, process 1900 of FIG. 19, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive, from a base station, a UE capability request message. In some aspects, the transmission component 1304 may transmit, to the base station in response to the UE capability request message, a UE capability information message that indicates one or more UE capabilities associated with one of an NTN, a TN, or both the NTN and the TN. In some aspects, the transmission component 1304 may transmit, to the base station in response to the UE capability request message, a UE capability information message that indicates one or more UE capabilities associated with one of unlicensed spectrum, licensed spectrum, or both unlicensed spectrum and licensed spectrum.

In some aspects, the reception component 1302 may receive, from the base station, an indication that the one or more UE capabilities associated with a particular one of the NTN, the TN, or both the NTN and the TN are to be indicated in the UE capability information message. In some aspects, the reception component 1302 may receive, from the base station, an indication that the one or more UE capabilities associated with a particular one of unlicensed spectrum, licensed spectrum, or both unlicensed spectrum and licensed spectrum are to be indicated in the UE capability information message

The reception component 1302 may receive, from the base station, an indication of one or more bands or band combinations for which the UE capability information message is to indicate per-band UE capabilities.

In some aspects, the determination component 1308 may determine based at least in part on network information that the UE is to indicate the one or more UE capabilities associated with a particular one of the NTN, the TN, or both the NTN and the TN in the UE capability information message. In some aspects, the determination component 1308 may determine based at least in part on network information that the UE is to indicate the one or more UE capabilities associated with a particular one of unlicensed spectrum, licensed spectrum, or both unlicensed spectrum and licensed spectrum in the UE capability information message.

In some aspects, the determination component 1308 may determine based at least in part on UE information that the UE is to indicate the one or more UE capabilities associated with a particular one of the NTN, the TN, or both the NTN and the TN in the UE capability information message. In some aspects, the determination component 1308 may determine based at least in part on UE information that the UE is to indicate the one or more UE capabilities associated with a particular one of the unlicensed spectrum, licensed spectrum, or both unlicensed spectrum and licensed spectrum in the UE capability information message.

In some aspects, the reception component 1302 may receive, from the base station, an indication that the UE is to prioritize indicating the one or more UE capabilities associated with a particular one of the NTN or the TN in the UE capability information message. In some aspects, the prioritization component 1310 may prioritize the UE capability information message to prioritize indicating the one or more UE capabilities associated with the particular one of the NTN or the TN. In some aspects, the reception component 1302 may receive, from the base station, an indication that the UE is to prioritize indicating the one or more UE capabilities associated with a particular one of unlicensed spectrum or licensed spectrum in the UE capability information message. In some aspects, the prioritization component 1310 may prioritize the UE capability information message to prioritize indicating the one or more UE capabilities associated with the particular one of unlicensed spectrum or licensed spectrum.

In some aspects, the determination component 1308 may determine based at least in part on at least one of network information or UE information that the UE is to prioritize indicating the one or more UE capabilities associated with a particular one of the NTN or the TN in the UE capability information message. In some aspects, the prioritization component 1310 may prioritize the UE capability information message to prioritize indicating the one or more UE capabilities associated with the particular one of the NTN or the TN. In some aspects, the determination component 1308 may determine based at least in part on at least one of network information or UE information that the UE is to prioritize indicating the one or more UE capabilities associated with a particular one of unlicensed spectrum or licensed spectrum in the UE capability information message. In some aspects, the prioritization component 1310 may prioritize the UE capability information message to prioritize indicating the one or more UE capabilities associated with the particular one of unlicensed spectrum or licensed spectrum.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

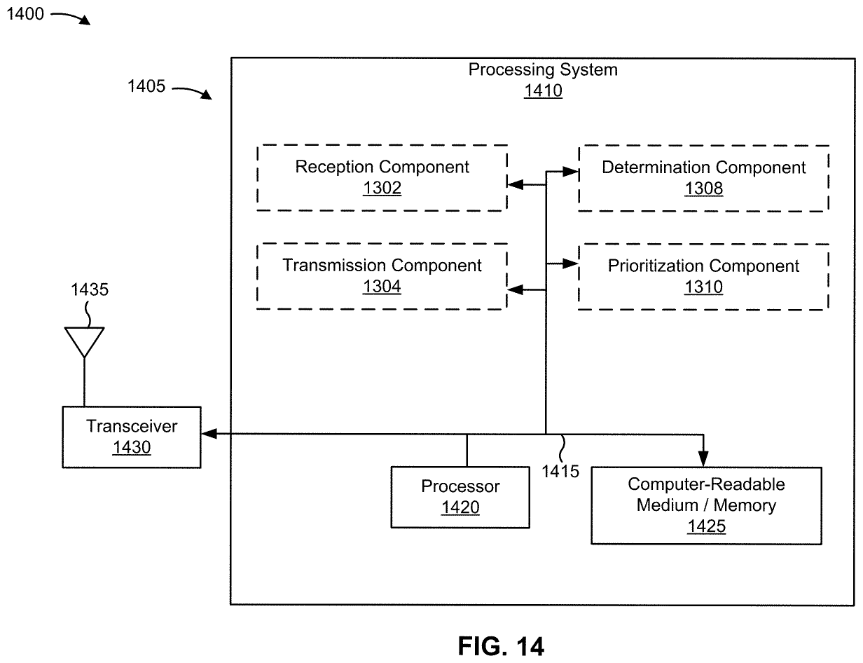

FIG. 14 is a diagram illustrating an example 1400 of a hardware implementation for an apparatus 1405 employing a processing system 1410. The apparatus 1405 may be a UE.

The processing system 1410 may be implemented with a bus architecture, represented generally by the bus 1415. The bus 1415 may include any number of interconnecting buses and bridges depending on the specific application of the processing system 1410 and the overall design constraints. The bus 1415 links together various circuits including one or more processors and/or hardware components, represented by the processor 1420, the illustrated components, and the computer-readable medium/memory 1425. The bus 1415 may also link various other circuits, such as timing sources, peripherals, voltage regulators, and/or power management circuits.

The processing system 1410 may be coupled to a transceiver 1430. The transceiver 1430 is coupled to one or more antennas 1435. The transceiver 1430 provides a means for communicating with various other apparatuses over a transmission medium. The transceiver 1430 receives a signal from the one or more antennas 1435, extracts information from the received signal, and provides the extracted information to the processing system 1410, specifically the reception component 1302. In addition, the transceiver 1430 receives information from the processing system 1410, specifically the transmission component 1304, and generates a signal to be applied to the one or more antennas 1435 based at least in part on the received information.

The processing system 1410 includes a processor 1420 coupled to a computer-readable medium/memory 1425. The processor 1420 is responsible for general processing, including the execution of software stored on the computer-readable medium/memory 1425. The software, when executed by the processor 1420, causes the processing system 1410 to perform the various functions described herein for any particular apparatus. The computer-readable medium/memory 1425 may also be used for storing data that is manipulated by the processor 1420 when executing software. The processing system further includes at least one of the illustrated components. The components may be software modules running in the processor 1420, resident/stored in the computer readable medium/memory 1425, one or more hardware modules coupled to the processor 1420, or some combination thereof.

In some aspects, the processing system 1410 may be a component of the UE 120 and may include the memory 282 and/or at least one of the TX MIMO processor 266, the receive processor 258, and/or the controller/processor 280. In some aspects, the apparatus 1405 for wireless communication includes means for receiving a UE capability request message; and/or means for transmitting, in response to the UE capability request message, a UE capability information message that indicates one or more UE capabilities associated with one of an NTN, a TN, or both the NTN and the TN. In some aspects, the apparatus 1405 for wireless communication includes means for receiving a UE capability request message; and/or means for transmitting, in response to the UE capability request message, a UE capability information message that indicates one or more UE capabilities associated with one of unlicensed spectrum, licensed spectrum, or both unlicensed spectrum and licensed spectrum. The aforementioned means may be one or more of the aforementioned components of the apparatus 1300 and/or the processing system 1410 of the apparatus 1405 configured to perform the functions recited by the aforementioned means. As described elsewhere herein, the processing system 1410 may include the transmit MIMO processor 266, the receive processor 258, and/or the controller/processor 280. In one configuration, the aforementioned means may be the transmit MIMO processor 266, the receive processor 258, and/or the controller/processor 280 configured to perform the functions and/or operations recited herein.

FIG. 14 is provided as an example. Other examples may differ from what is described in connection with FIG. 14.

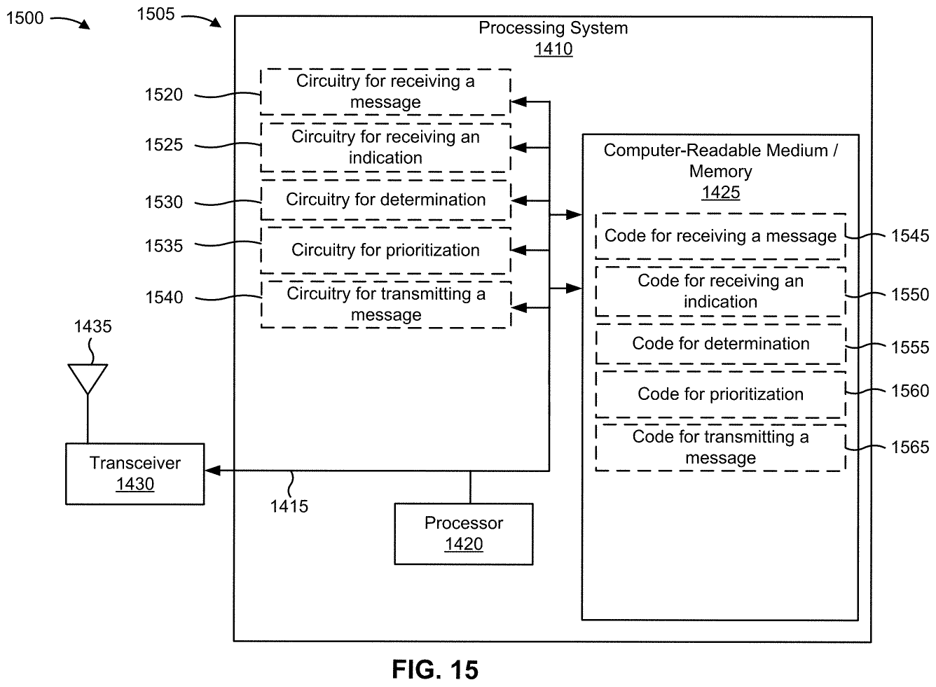

FIG. 15 is a diagram illustrating an example 1500 of an implementation of code and circuitry for an apparatus 1505, in accordance with the present disclosure. The apparatus 1505 may be a UE.

As shown in FIG. 15, the apparatus 1505 may include circuitry for receiving a message (circuitry 1520). For example, the circuitry 1520 may provide means for receiving a UE capability request message.

As shown in FIG. 15, the apparatus 1505 may include circuitry for receiving an indication (circuitry 1525). For example, the circuitry 1525 may provide means for receiving an indication that the apparatus 1505 is to indicate one or more UE capabilities associated with a particular one of an NTN, a TN, or both the NTN and the TN in a UE capability information message; means for receiving an indication that the apparatus 1505 is to indicate one or more UE capabilities associated with a particular one of unlicensed spectrum, licensed spectrum, or both unlicensed spectrum and licensed spectrum in a UE capability information message; means for receiving an indication that the apparatus 1505 is to prioritize indicating the one or more UE capabilities associated with a particular one of the NTN or the TN in the UE capability information message; and/or means for receiving an indication that the apparatus 1505 is to prioritize indicating the one or more UE capabilities associated with a particular one of unlicensed spectrum or licensed spectrum in the UE capability information message.

As shown in FIG. 15, the apparatus 1505 may include circuitry for determination (circuitry 1530). For example, the circuitry 1530 may provide means for determining based at least in part on network information and/or UE information that the apparatus 1505 is to indicate the one or more UE capabilities associated with a particular one of the NTN, the TN, or both the NTN and the TN in the UE capability information message; means for determining based at least in part on network information and/or UE information that the apparatus 1505 is to indicate the one or more UE capabilities associated with a particular one of unlicensed spectrum, licensed spectrum, or both unlicensed spectrum and licensed spectrum in the UE capability information message; means for determining based at least in part on network information and/or UE information that the apparatus 1505 is to prioritize indicating the one or more UE capabilities associated with a particular one of the NTN or the TN in the UE capability information message; and/or means for determining based at least in part on network information and/or UE information that the apparatus 1505 is to prioritize indicating the one or more UE capabilities associated with a particular one of unlicensed spectrum or licensed spectrum in the UE capability information message.

As shown in FIG. 15, the apparatus 1505 may include circuitry for prioritization (circuitry 1535). For example, the circuitry 1535 may provide means for prioritizing indicating the one or more UE capabilities associated with a particular one of the NTN or the TN in the UE capability information message; and/or means for prioritizing indicating the one or more UE capabilities associated with a particular one of unlicensed spectrum or licensed spectrum in the UE capability information message.

As shown in FIG. 15, the apparatus 1505 may include circuitry for transmitting a message (circuitry 1540). For example, the circuitry 1540 may provide means for transmitting, in response to the UE capability request message, a UE capability information message.

The circuitry 1520, 1525, 1530, 1535, and/or 1540 may include one or more components of the UE described above in connection with FIG. 2, such as transmit processor 264, transmit MIMO processor 266, modem 254, MIMO detector 256, receive processor 258, antenna 252, controller/processor 280, and/or memory 282.

As shown in FIG. 15, the apparatus 1505 may include, stored in computer-readable medium 1425, code for receiving a message (code 1545). For example, the code 1545, when executed by the processor 1420, may cause the apparatus 1505 to receive a UE capability request message.

As shown in FIG. 15, the apparatus 1505 may include, stored in computer-readable medium 1425, code for receiving an indication (code 1550). For example, the code 1550, when executed by the processor 1420, may cause the apparatus 1505 to receive an indication that the apparatus 1505 is to indicate one or more UE capabilities associated with a particular one of an NTN, a TN, or both the NTN and the TN in a UE capability information message; receive an indication that the apparatus 1505 is to indicate one or more UE capabilities associated with a particular one of unlicensed spectrum, licensed spectrum, or both unlicensed spectrum and licensed spectrum in a UE capability information message; receive an indication that the apparatus 1505 is to prioritize indicating the one or more UE capabilities associated with a particular one of the NTN or the TN in the UE capability information message; and/or receive an indication that the apparatus 1505 is to prioritize indicating the one or more UE capabilities associated with a particular one of unlicensed spectrum or licensed spectrum in the UE capability information message.

As shown in FIG. 15, the apparatus 1505 may include, stored in computer-readable medium 1425, code for determination (code 1555). For example, the code 1555, when executed by the processor 1420, may cause the apparatus 1505 to determine based at least in part on network information and/or UE information that the apparatus 1505 is to indicate the one or more UE capabilities associated with a particular one of the NTN, the TN, or both the NTN and the TN in the UE capability information message; determine based at least in part on network information and/or UE information that the apparatus 1505 is to indicate the one or more UE capabilities associated with a particular one of unlicensed spectrum, licensed spectrum, or both unlicensed spectrum and licensed spectrum in the UE capability information message;

determine based at least in part on network information and/or UE information that the apparatus 1505 is to prioritize indicating the one or more UE capabilities associated with a particular one of the NTN or the TN in the UE capability information message; and/or determine based at least in part on network information and/or UE information that the apparatus 1505 is to prioritize indicating the one or more UE capabilities associated with a particular one of unlicensed spectrum or licensed spectrum in the UE capability information message.

As shown in FIG. 15, the apparatus 1505 may include, stored in computer-readable medium 1425, code for prioritization (code 1560). For example, the code 1560, when executed by the processor 1420, may cause the apparatus 1505 to prioritize indicating the one or more UE capabilities associated with a particular one of the NTN or the TN in the UE capability information message; and/or prioritize indicating the one or more UE capabilities associated with a particular one of unlicensed spectrum or licensed spectrum in the UE capability information message.

As shown in FIG. 15, the apparatus 1505 may include, stored in computer-readable medium 1425, code for transmitting a message (code 1565). For example, the code 1565, when executed by the processor 1420, may cause the apparatus 1505 to transmit, in response to the UE capability request message, a UE capability information message.

FIG. 15 is provided as an example. Other examples may differ from what is described in connection with FIG. 15.

FIG. 16 is a diagram of an example apparatus 1600 for wireless communication. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 140. The communication manager 140 may include a configuration component 1608, among other examples.

In some aspects, the apparatus 1600 may be configured to perform one or more operations described herein in connection with FIGS. 7-8. Additionally, or alternatively, the apparatus 1600 may be configured to perform one or more processes described herein, such as process 1000 of FIG. 10, process 1200 of FIG. 12, process 2000 of FIG. 20, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The transmission component 1604 may transmit, to a UE, a UE capability request message. In some aspects, the reception component 1602 may receive, from the UE in response to the UE capability request message, a UE capability information message that indicates one or more UE capabilities associated with one of an NTN, a TN, or both the NTN and the TN. In some aspects, the reception component 1602 may receive, from the UE in response to the UE capability request message, a UE capability information message that indicates one or more UE capabilities associated with one of unlicensed spectrum, licensed spectrum, or both unlicensed spectrum and licensed spectrum.

In some aspects, the transmission component 1604 may transmit, to the UE, an indication that the one or more UE capabilities associated with a particular one of the NTN, the TN, or both the NTN and the TN are to be indicated in the UE capability information message. In some aspects, the transmission component 1604 may transmit, to the UE, an indication that the one or more UE capabilities associated with a particular one of unlicensed spectrum, licensed spectrum, or both unlicensed spectrum and licensed spectrum are to be indicated in the UE capability information message.

The transmission component 1604 may transmit, to the UE, an indication of one or more bands or band combinations for which the UE capability information message is to indicate per-band UE capabilities.

In some aspects, the transmission component 1604 may transmit, to the UE, an indication that the UE is to prioritize indicating the one or more UE capabilities associated with a particular one of the NTN or the TN in the UE capability information message. In some aspects, the transmission component 1604 may transmit, to the UE, an indication that the UE is to prioritize indicating the one or more UE capabilities associated with a particular one of unlicensed spectrum or licensed spectrum in the UE capability information message.

The configuration component 1608 may determine a configuration for the UE based at least in part on the UE capability information.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

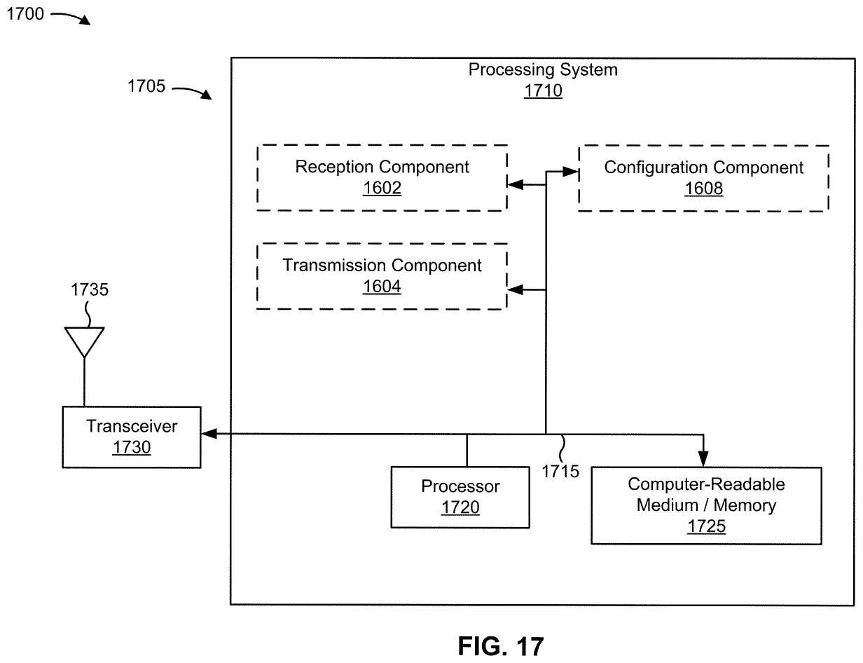

FIG. 17 is a diagram illustrating an example 1700 of a hardware implementation for an apparatus 1705 employing a processing system 1710. The apparatus 1705 may be a base station.

The processing system 1710 may be implemented with a bus architecture, represented generally by the bus 1715. The bus 1715 may include any number of interconnecting buses and bridges depending on the specific application of the processing system 1710 and the overall design constraints. The bus 1715 links together various circuits including one or more processors and/or hardware components, represented by the processor 1720, the illustrated components, and the computer-readable medium/memory 1725. The bus 1715 may also link various other circuits, such as timing sources, peripherals, voltage regulators, and/or power management circuits.

The processing system 1710 may be coupled to a transceiver 1730. The transceiver 1730 is coupled to one or more antennas 1735. The transceiver 1730 provides a means for communicating with various other apparatuses over a transmission medium. The transceiver 1730 receives a signal from the one or more antennas 1735, extracts information from the received signal, and provides the extracted information to the processing system 1710, specifically the reception component 1602. In addition, the transceiver 1730 receives information from the processing system 1710, specifically the transmission component 1604, and generates a signal to be applied to the one or more antennas 1735 based at least in part on the received information.

The processing system 1710 includes a processor 1720 coupled to a computer-readable medium/memory 1725. The processor 1720 is responsible for general processing, including the execution of software stored on the computer-readable medium/memory 1725. The software, when executed by the processor 1720, causes the processing system 1710 to perform the various functions described herein for any particular apparatus. The computer-readable medium/memory 1725 may also be used for storing data that is manipulated by the processor 1720 when executing software. The processing system further includes at least one of the illustrated components. The components may be software modules running in the processor 1720, resident/stored in the computer readable medium/memory 1725, one or more hardware modules coupled to the processor 1720, or some combination thereof.

In some aspects, the processing system 1710 may be a component of the base station 110 and may include the memory 242 and/or at least one of the TX MIMO processor 230, the receive processor 238, and/or the controller/processor 240. In some aspects, the apparatus 1705 for wireless communication includes means for transmitting a UE capability request message; and/or means for receiving, in response to the UE capability request message, a UE capability information message that indicates one or more UE capabilities associated with one of an NTN, a TN, or both the NTN and the TN. In some aspects, the apparatus 1705 for wireless communication includes means for transmitting a UE capability request message; and/or means for receiving, in response to the UE capability request message, a UE capability information message that indicates one or more UE capabilities associated with one of unlicensed spectrum, licensed spectrum, or both unlicensed spectrum and licensed spectrum. The aforementioned means may be one or more of the aforementioned components of the apparatus 1600 and/or the processing system 1710 of the apparatus 1705 configured to perform the functions recited by the aforementioned means. As described elsewhere herein, the processing system 1710 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 17 is provided as an example. Other examples may differ from what is described in connection with FIG. 17.

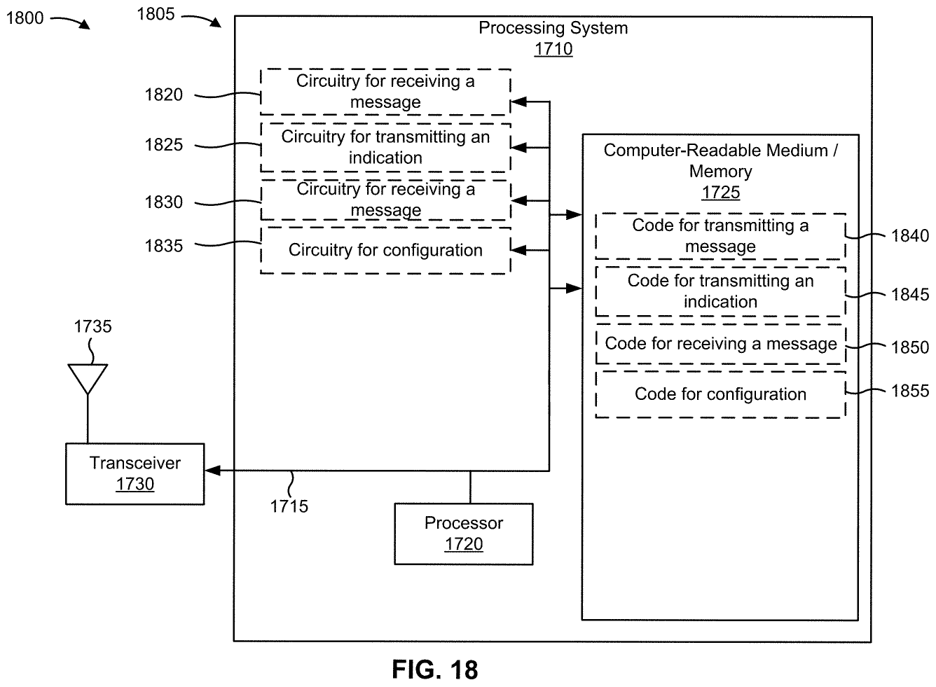

FIG. 18 is a diagram illustrating an example 1800 of an implementation of code and circuitry for an apparatus 1805, in accordance with the present disclosure. The apparatus 1805 may be a UE.

As shown in FIG. 18, the apparatus 1805 may include circuitry for transmitting a message (circuitry 1820). For example, the circuitry 1820 may provide means for transmitting a UE capability request message.

As shown in FIG. 18, the apparatus 1805 may include circuitry for transmitting an indication (circuitry 1825). For example, the circuitry 1825 may provide means for transmitting an indication that one or more UE capabilities associated with a particular one of an NTN, a TN, or both the NTN and the TN are to be indicated in a UE capability information message; means for transmitting an indication that one or more UE capabilities associated with a particular one of unlicensed spectrum, licensed spectrum, or both unlicensed spectrum and licensed spectrum are to be indicated in a UE capability information message; means for transmitting an indication that UE is to prioritize indicating the one or more UE capabilities associated with a particular one of the NTN or the TN in the UE capability information message; and/or means for transmitting an indication that the UE is to prioritize indicating the one or more UE capabilities associated with a particular one of unlicensed spectrum or licensed spectrum in the UE capability information message.

As shown in FIG. 18, the apparatus 1805 may include circuitry for receiving a message (circuitry 1830). For example, the circuitry 1830 may provide means for receiving, in response to the UE capability request message, a UE capability information message.

As shown in FIG. 18, the apparatus 1805 may include circuitry for configuration (circuitry 1835). For example, the circuitry 1835 may provide means for determining a configuration for the UE based at least in part on the UE capability information.

The circuitry 1820, 1825, 1830, and/or 1835 may include one or more components of the UE described above in connection with FIG. 2, such as transmit processor 264, transmit MIMO processor 266, modem 254, MIMO detector 256, receive processor 258, antenna 252, controller/processor 280, and/or memory 282.

As shown in FIG. 18, the apparatus 1805 may include, stored in computer-readable medium 1725, code for transmitting a message (code 1840). For example, the code 1840, when executed by the processor 1720, may cause the apparatus 1805 to transmit a UE capability request message.

As shown in FIG. 18, the apparatus 1805 may include, stored in computer-readable medium 1725, code for transmitting an indication (code 1845). For example, the code 1845, when executed by the processor 1720, may cause the apparatus 1805 to transmit an indication that one or more UE capabilities associated with a particular one of an NTN, a TN, or both the NTN and the TN are to be indicated in a UE capability information message; transmit an indication that one or more UE capabilities associated with a particular one of unlicensed spectrum, licensed spectrum, or both unlicensed spectrum and licensed spectrum are to be indicated in a UE capability information message; transmit an indication that the UE is to prioritize indicating the one or more UE capabilities associated with a particular one of the NTN or the TN in the UE capability information message; and/or transmit an indication that the UE is to prioritize indicating the one or more UE capabilities associated with a particular one of unlicensed spectrum or licensed spectrum in the UE capability information message.

As shown in FIG. 18, the apparatus 1805 may include, stored in computer-readable medium 1725, code for receiving a message (code 1850). For example, the code 1850, when executed by the processor 1720, may cause the apparatus 1805 to receive, in response to the UE capability request message, a UE capability information message.

As shown in FIG. 18, the apparatus 1805 may include, stored in computer-readable medium 1725, code for configuration (code 1855). For example, the code 1855, when executed by the processor 1720, may cause the apparatus 1805 to determine a configuration for the UE based at least in part on the UE capability information.

FIG. 18 is provided as an example. Other examples may differ from what is described in connection with FIG. 18.

FIG. 19 is a diagram illustrating an example process 1900 performed, for example, by a UE, in accordance with the present disclosure. Example process 1900 is an example where the UE (e.g., UE 120) performs operations associated with selective reporting of UE capability information.

As shown in FIG. 19, in some aspects, process 1900 may include receiving a UE capability request message (block 1910). For example, the UE (e.g., using communication manager 140 and/or reception component 1302, depicted in FIG. 13) may receive a UE capability request message, as described above.

In some aspects, process 1900 may include determining, based at least in part on network information, that one or more UE capabilities associated with a particular one of the NTN, the TN, or both the NTN and the TN, are to be indicated in the UE capability information message (block 1912). For example, the UE (e.g., using communication manager 140 and/or determination component 1308, depicted in FIG. 13) may determine, based at least in part on network information, that one or more UE capabilities associated with a particular one of the NTN, the TN, or both the NTN and the TN, are to be indicated in the UE capability information message, as described above.

As further shown in FIG. 19, in some aspects, process 1900 may include transmitting, in response to the UE capability request message, based at least in part on network information, the UE capability information message that indicates one or more UE capabilities associated with one of the NTN, the TN, or both the NTN and the TN (block 1920). For example, the UE (e.g., using communication manager 140 and/or transmission component 1304, depicted in FIG. 13) may transmit, in response to the UE capability request message, based at least in part on network information, the UE capability information message that indicates one or more UE capabilities associated with one of the NTN, the TN, or both the NTN and the TN, as described above.

Process 1900 may include additional aspects, such as any single aspect or any combination of aspects described below and/or in connection with one or more other processes described elsewhere herein.

In a first aspect, process 1900 includes receiving an indication that the one or more UE capabilities associated with a particular one of the NTN, the TN, or both the NTN and the TN are to be indicated in the UE capability information message, where the UE capability information message indicates the one or more UE capabilities in accordance with the indication.

In a second aspect, alone or in combination with the first aspect, process 1900 includes receiving an indication of one or more bands or band combinations for which the UE capability information message is to indicate per-band UE capabilities, where the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

In a third aspect, alone or in combination with one or more of the first and second aspects, process 1900 includes determining based at least in part on the network information that the UE is to indicate the one or more UE capabilities associated with a particular one of the NTN, the TN, or both the NTN and the TN in the UE capability information message, where the UE capability information message indicates the one or more UE capabilities associated with the particular one of the NTN, the TN, or both the NTN and the TN.

In a fourth aspect, alone or in combination with one or more of the first through third aspects, the network information includes at least one of serving cell information indicating that a serving cell for the UE is operated in the NTN or the TN, or neighboring cell information indicating that a neighboring cell for the UE is operated in the NTN or the TN.

In a fifth aspect, alone or in combination with one or more of the first through fourth aspects, the UE capability information message, further based at least in part on UE information, indicates the one or more UE capabilities associated with the one of the NTN, the TN, or both the NTN and the TN.

In a sixth aspect, alone or in combination with one or more of the first through fifth aspects, the UE information includes at least one of a type of the UE, a location of the UE, a quality of service for communications of the UE, a connection history of the UE, or a speed of movement of the UE.

In a seventh aspect, alone or in combination with one or more of the first through sixth aspects, the UE capability information message indicates the one or more UE capabilities associated with the NTN in a field of the UE capability information message designated for capability indication for the TN.

In an eighth aspect, alone or in combination with one or more of the first through seventh aspects, the UE capability information message includes an indication that the one or more UE capabilities associated with the NTN are in the field of the UE capability information message designated for capability indication for the TN.

In a ninth aspect, alone or in combination with one or more of the first through eighth aspects, the UE capability information message indicates the one or more UE capabilities associated with the NTN in a field of the UE capability information message designated for capability indication for the NTN.

In a tenth aspect, alone or in combination with one or more of the first through ninth aspects, the UE capability information message indicates, in an additional field of the UE capability information message designated for capability indication for the TN, that all features for the additional field lack support.

In an eleventh aspect, alone or in combination with one or more of the first through tenth aspects, the UE capability information message prioritizes indicating the one or more UE capabilities associated with one of the NTN or the TN.

In a twelfth aspect, alone or in combination with one or more of the first through eleventh aspects, process 1900 includes receiving an indication that the UE is to prioritize indicating the one or more UE capabilities associated with a particular one of the NTN or the TN in the UE capability information message, wherein the UE capability information message prioritizes indicating the one or more UE capabilities associated with the particular one of the NTN or the TN.

In a thirteenth aspect, alone or in combination with one or more of the first through twelfth aspects, process 1900 includes determining, based at least in part on at least one of network information or UE information, that the UE is to prioritize indicating the one or more UE capabilities associated with a particular one of the NTN or the TN in the UE capability information message, where the UE capability information message prioritizes indicating the one or more UE capabilities associated with the particular one of the NTN or the TN.

In a fourteenth aspect, alone or in combination with one or more of the first through thirteenth aspects, the UE capability information message includes an indication that the UE capability information message prioritizes indicating the one or more UE capabilities associated with one of the NTN or the TN.

In a fifteenth aspect, alone or in combination with one or more of the first through fourteenth aspects, the UE is an NTN only UE, and the UE capability information message indicates the one or more UE capabilities associated with only the NTN.

In a sixteenth aspect, alone or in combination with one or more of the first through fifteenth aspects, the UE capability information message includes an indication that the UE is the NTN only UE or that the one or more UE capabilities are associated with only the NTN.

In a seventeenth aspect, alone or in combination with one or more of the first through sixteenth aspects, the UE capability information message indicates the one or more UE capabilities using one or more feature group indications.

In an eighteenth aspect, alone or in combination with one or more of the first through seventeenth aspects, process 1900 includes receiving the network information in one or more of a master information block, a system information block, or UE-dedicated signaling.

In a nineteenth aspect, alone or in combination with one or more of the first through eighteenth aspects, the one or more UE capabilities are one or more per-UE capabilities.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a diagram illustrating an example process 2000 performed, for example, by a network node, in accordance with the present disclosure. Example process 2000 is an example where the network node (e.g., base station 110) performs operations associated with selective reporting of UE capability information.

As shown in FIG. 20, in some aspects, process 2000 may include transmitting a UE capability request message for a UE (block 2010). For example, the network node (e.g., using communication manager 150 and/or transmission component 1604, depicted in FIG. 16) may transmit a UE capability request message for a UE, as described above.

As further shown in FIG. 20, in some aspects, process 2000 may include receiving, in response to the UE capability request message, based at least in part on network information, a UE capability information message for the UE that indicates one or more UE capabilities associated with one of the NTN, the TN, or both the NTN and the TN (block 2020). For example, the network node (e.g., using communication manager 150 and/or reception component 1602, depicted in FIG. 16) may receive, in response to the UE capability request message, based at least in part on network information, a UE capability information message for the UE that indicates one or more UE capabilities associated with one of the NTN, the TN, or both the NTN and the TN, as described above.

Process 2000 may include additional aspects, such as any single aspect or any combination of aspects described below and/or in connection with one or more other processes described elsewhere herein.

In a first aspect, process 2000 includes transmitting an indication that the one or more UE capabilities associated with a particular one of the NTN, the TN, or both the NTN and the TN are to be indicated in the UE capability information message, where the UE capability information message indicates the one or more UE capabilities in accordance with the indication.

In a second aspect, alone or in combination with the first aspect, process 2000 includes transmitting an indication of one or more bands or band combinations for which the UE capability information message is to indicate per-band UE capabilities, where the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

In a third aspect, alone or in combination with one or more of the first and second aspects, the network information includes at least one of serving cell information indicating that a serving cell for the UE is operated in the NTN or the TN, or neighbor cell information indicating that a neighboring cell for the UE is operated in the NTN or the TN.

In a fourth aspect, alone or in combination with one or more of the first through third aspects, the UE capability information message indicates the one or more UE capabilities associated with the NTN in a field of the UE capability information message designated for capability indication for the TN.

In a fifth aspect, alone or in combination with one or more of the first through fourth aspects, the UE capability information message includes an indication that the one or more UE capabilities associated with the NTN are in the field of the UE capability information message designated for capability indication for the TN.

In a sixth aspect, alone or in combination with one or more of the first through fifth aspects, the UE capability information message indicates the one or more UE capabilities associated with the NTN in a field of the UE capability information message designated for capability indication for the NTN.

In a seventh aspect, alone or in combination with one or more of the first through sixth aspects, the UE capability information message indicates, in an additional field of the UE capability information message designated for capability indication for the TN, that all features for the additional field lack support.

In an eighth aspect, alone or in combination with one or more of the first through seventh aspects, the UE capability information message prioritizes indicating the one or more UE capabilities associated with one of the NTN or the TN.

In a ninth aspect, alone or in combination with one or more of the first through eighth aspects, process 2000 includes transmitting an indication that the UE is to prioritize indicating the one or more UE capabilities associated with a particular one of the NTN or the TN in the UE capability information message, where the UE capability information message prioritizes indicating the one or more UE capabilities associated with the particular one of the NTN or the TN.

In a tenth aspect, alone or in combination with one or more of the first through ninth aspects, the UE capability information message includes an indication that the UE capability information message prioritizes indicating the one or more UE capabilities associated with one of the NTN or the TN.

In an eleventh aspect, alone or in combination with one or more of the first through tenth aspects, the UE is an NTN only UE, and the UE capability information message indicates the one or more UE capabilities associated with only the NTN.

In a twelfth aspect, alone or in combination with one or more of the first through eleventh aspects, the UE capability information message includes an indication that the UE is the NTN only UE or that the one or more UE capabilities are associated with only the NTN.

In a thirteenth aspect, alone or in combination with one or more of the first through twelfth aspects, the UE capability information message indicates the one or more UE capabilities using one or more feature group indications.

In a fourteenth aspect, alone or in combination with one or more of the first through thirteenth aspects, process 2000 includes transmitting the network information in one or more of a master information block, a system information block, or UE-dedicated signaling.

In a fifteenth aspect, alone or in combination with one or more of the first through fourteenth aspects, the one or more UE capabilities are one or more per-UE capabilities.

Although FIG. 20 shows example blocks of process 2000, in some aspects, process 2000 may include additional blocks, fewer blocks, different blocks, or differently arranged blocks than those depicted in FIG. 20. Additionally, or alternatively, two or more of the blocks of process 2000 may be performed in parallel.

The following provides an overview of some Aspects of the present disclosure:

Aspect 1: A method of wireless communication performed by an apparatus of a user equipment (UE), comprising: receiving a UE capability request message; and transmitting, in response to the UE capability request message, based at least in part on network information, a UE capability information message that indicates one or more UE capabilities associated with one of a non-terrestrial network (NTN), a terrestrial network (TN), or both the NTN and the TN.

Aspect 2: The method of Aspect 1, further comprising: receiving an indication that the one or more UE capabilities associated with a particular one of the NTN, the TN, or both the NTN and the TN are to be indicated in the UE capability information message, wherein the UE capability information message indicates the one or more UE capabilities in accordance with the indication.

Aspect 3: The method of any of Aspects 1-2, further comprising: receiving an indication of one or more bands or band combinations for which the UE capability information message is to indicate per-band UE capabilities, wherein the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

Aspect 4: The method of any of Aspects 1-3, further comprising: determining based at least in part on the network information that the UE is to indicate the one or more UE capabilities associated with a particular one of the NTN, the TN, or both the NTN and the TN in the UE capability information message, wherein the UE capability information message indicates the one or more UE capabilities associated with the particular one of the NTN, the TN, or both the NTN and the TN.

Aspect 5: The method of any of Aspects 1-4, where the network information includes at least one of: serving cell information indicating that a serving cell for the UE is operated in the NTN or the TN, or neighboring cell information indicating that a neighboring cell for the UE is operated in the NTN or the TN.

Aspect 6: The method of any of Aspects 1-5, wherein the UE capability information message, further based at least in part on UE information, indicates the one or more UE capabilities associated with the one of the NTN, the TN, or both the NTN and the TN.

Aspect 7: The method of Aspect 6, wherein the UE information includes at least one of: a type of the UE, a location of the UE, a quality of service for communications of the UE, a connection history of the UE, or a speed of movement of the UE.

Aspect 8: The method of any of Aspects 1-7, wherein the UE capability information message indicates the one or more UE capabilities associated with the NTN in a field of the UE capability information message designated for capability indication for the TN.

Aspect 9: The method of Aspect 8, wherein the UE capability information message includes an indication that the one or more UE capabilities associated with the NTN are in the field of the UE capability information message designated for capability indication for the TN.

Aspect 10: The method of any of Aspects 1-9, wherein the UE capability information message indicates the one or more UE capabilities associated with the NTN in a field of the UE capability information message designated for capability indication for the NTN.

Aspect 11: The method of Aspect 10, wherein the UE capability information message indicates, in an additional field of the UE capability information message designated for capability indication for the TN, that all features for the additional field lack support.

Aspect 12: The method of any of Aspects 1-11, wherein the UE capability information message prioritizes indicating the one or more UE capabilities associated with one of the NTN or the TN.

Aspect 13: The method of Aspect 12, further comprising: receiving an indication that the UE is to prioritize indicating the one or more UE capabilities associated with a particular one of the NTN or the TN in the UE capability information message, wherein the UE capability information message prioritizes indicating the one or more UE capabilities associated with the particular one of the NTN or the TN.

Aspect 14: The method of any of Aspects 12-13, further comprising: determining based at least in part on at least one of network information or UE information that the UE is to prioritize indicating the one or more UE capabilities associated with a particular one of the NTN or the TN in the UE capability information message, wherein the UE capability information message prioritizes indicating the one or more UE capabilities associated with the particular one of the NTN or the TN.

Aspect 15: The method of any of Aspects 12-14, wherein the UE capability information message includes an indication that the UE capability information message prioritizes indicating the one or more UE capabilities associated with one of the NTN or the TN.

Aspect 16: The method of any of Aspects 1-15, wherein the UE is an NTN only UE, and the UE capability information message indicates the one or more UE capabilities associated with only the NTN.

Aspect 17: The method of Aspect 16, wherein the UE capability information message includes an indication that the UE is the NTN only UE or that the one or more UE capabilities are associated with only the NTN.

Aspect 18: The method of any of Aspects 1-17, wherein the UE capability information message indicates the one or more UE capabilities using one or more feature group indications.

Aspect 19: The method of any of Aspects 1-18, further comprising: receiving the network information in one or more of a master information block, a system information block, or UE-dedicated signaling.

Aspect 20: The method of any of Aspects 1-19, wherein the one or more UE capabilities are one or more per-UE capabilities.

Aspect 21: A method of wireless communication performed by an apparatus of a network node, comprising: transmitting a user equipment (UE) capability request message for a UE; and receiving, in response to the UE capability request message, based at least in part on network information, a UE capability information message for the UE that indicates one or more UE capabilities associated with one of a non-terrestrial network (NTN), a terrestrial network (TN), or both the NTN and the TN.

Aspect 22: The method of Aspect 21, further comprising: transmitting an indication that the one or more UE capabilities associated with a particular one of the NTN, the TN, or both the NTN and the TN are to be indicated in the UE capability information message, wherein the UE capability information message indicates the one or more UE capabilities in accordance with the indication.

Aspect 23: The method of any of Aspects 21-22, further comprising: transmitting an indication of one or more bands or band combinations for which the UE capability information message is to indicate per-band UE capabilities, wherein the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

Aspect 24: The method of any of Aspects 21-23, where the network information includes at least one of: serving cell information indicating that a serving cell for the UE is operated in the NTN or the TN, or neighbor cell information indicating that a neighboring cell for the UE is operated in the NTN or the TN.

Aspect 25: The method of any of Aspects 21-24, wherein the UE capability information message indicates the one or more UE capabilities associated with the NTN in a field of the UE capability information message designated for capability indication for the TN.

Aspect 26: The method of Aspect 25, wherein the UE capability information message includes an indication that the one or more UE capabilities associated with the NTN are in the field of the UE capability information message designated for capability indication for the TN.

Aspect 27: The method of any of Aspects 21-26, wherein the UE capability information message indicates the one or more UE capabilities associated with the NTN in a field of the UE capability information message designated for capability indication for the NTN.

Aspect 28: The method of Aspect 27, wherein the UE capability information message indicates, in an additional field of the UE capability information message designated for capability indication for the TN, that all features for the additional field lack support.

Aspect 29: The method of any of Aspects 21-28, wherein the UE capability information message prioritizes indicating the one or more UE capabilities associated with one of the NTN or the TN.

Aspect 30: The method of Aspect 29, further comprising: transmitting an indication that the UE is to prioritize indicating the one or more UE capabilities associated with a particular one of the NTN or the TN in the UE capability information message, wherein the UE capability information message prioritizes indicating the one or more UE capabilities associated with the particular one of the NTN or the TN.

Aspect 31: The method of any of Aspects 29-30, wherein the UE capability information message includes an indication that the UE capability information message prioritizes indicating the one or more UE capabilities associated with one of the NTN or the TN.

Aspect 32: The method of any of Aspects 21-31, wherein the UE is an NTN only UE, and the UE capability information message indicates the one or more UE capabilities associated with only the NTN.

Aspect 33: The method of Aspect 32, wherein the UE capability information message includes an indication that the UE is the NTN only UE or that the one or more UE capabilities are associated with only the NTN.

Aspect 34: The method of any of Aspects 21-33, wherein the UE capability information message indicates the one or more UE capabilities using one or more feature group indications.

Aspect 35: The method of any of Aspects 21-34, further comprising: transmitting the network information in one or more of a master information block, a system information block, or UE-dedicated signaling.

Aspect 36: The method of any of Aspects 21-35, wherein the one or more UE capabilities are one or more per-UE capabilities.

Aspect 37: An apparatus for wireless communication at a device, comprising a processor; memory coupled with the processor; and instructions stored in the memory and executable by the processor to cause the apparatus to perform the method of one or more of Aspects 1-20.

Aspect 38: A device for wireless communication, comprising a memory and one or more processors coupled to the memory, the one or more processors configured to perform the method of one or more of Aspects 1-20.

Aspect 39: An apparatus for wireless communication, comprising at least one means for performing the method of one or more of Aspects 1-20.

Aspect 40: A non-transitory computer-readable medium storing code for wireless communication, the code comprising instructions executable by a processor to perform the method of one or more of Aspects 1-20.

Aspect 41: A non-transitory computer-readable medium storing a set of instructions for wireless communication, the set of instructions comprising one or more instructions that, when executed by one or more processors of a device, cause the device to perform the method of one or more of Aspects 1-20.

Aspect 42: An apparatus for wireless communication at a device, comprising a processor; memory coupled with the processor; and instructions stored in the memory and executable by the processor to cause the apparatus to perform the method of one or more of Aspects 21-36.

Aspect 43: A device for wireless communication, comprising a memory and one or more processors coupled to the memory, the one or more processors configured to perform the method of one or more of Aspects 21-36.

Aspect 44: An apparatus for wireless communication, comprising at least one means for performing the method of one or more of Aspects 21-36.

Aspect 45: A non-transitory computer-readable medium storing code for wireless communication, the code comprising instructions executable by a processor to perform the method of one or more of Aspects 21-36.

Aspect 46: A non-transitory computer-readable medium storing a set of instructions for wireless communication, the set of instructions comprising one or more instructions that, when executed by one or more processors of a device, cause the device to perform the method of one or more of Aspects 21-36.

Aspect 47: A method of wireless communication performed by an apparatus of a user equipment (UE), comprising: receiving, from a base station, a UE capability request message; and transmitting, to the base station in response to the UE capability request message, a UE capability information message that indicates one or more UE capabilities associated with one of a non-terrestrial network (NTN), a terrestrial network (TN), or both the NTN and the TN.

Aspect 48: The method of Aspect 47, further comprising: receiving, from the base station, an indication that the one or more UE capabilities associated with a particular one of the NTN, the TN, or both the NTN and the TN are to be indicated in the UE capability information message, wherein the UE capability information message indicates the one or more UE capabilities in accordance with the indication.

Aspect 49: The method of any of Aspects 47-48, further comprising: receiving, from the base station, an indication of one or more bands or band combinations for which the UE capability information message is to indicate per-band UE capabilities, wherein the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

Aspect 50: The method of any of Aspects 47-49, further comprising: determining based at least in part on network information that the UE is to indicate the one or more UE capabilities associated with a particular one of the NTN, the TN, or both the NTN and the TN in the UE capability information message, wherein the UE capability information message indicates the one or more UE capabilities associated with the particular one of the NTN, the TN, or both the NTN and the TN.

Aspect 51: The method of Aspect 50, where the network information includes at least one of: serving cell information indicating that a serving cell for the UE is operated in the NTN or the TN, or neighboring cell information indicating that a neighboring cell for the UE is operated in the NTN or the TN.

Aspect 52: The method of any of Aspects 47-51, further comprising: determining based at least in part on UE information that the UE is to indicate the one or more UE capabilities associated with a particular one of the NTN, the TN, or both the NTN and the TN in the UE capability information message, wherein the UE capability information message indicates the one or more UE capabilities for the particular one of the NTN, the TN, or both the NTN and the TN.

Aspect 53: The method of Aspect 52, wherein the UE information includes at least one of: a type of the UE, a location of the UE, a quality of service for communications of the UE, a connection history of the UE, or a speed of movement of the UE.

Aspect 54: The method of any of Aspects 47-54, wherein the UE capability information message indicates the one or more UE capabilities associated with the NTN in a field of the UE capability information message designated for capability indication for the TN.

Aspect 55: The method of Aspect 54, wherein the UE capability information message includes an indication that the one or more UE capabilities associated with the NTN are in the field of the UE capability information message designated for capability indication for the TN.

Aspect 56: The method of any of Aspects 47-54, wherein the UE capability information message indicates the one or more UE capabilities associated with the NTN in a field of the UE capability information message designated for capability indication for the NTN.

Aspect 57: The method of Aspect 56, wherein the UE capability information message indicates, in an additional field of the UE capability information message designated for capability indication for the TN, that all features for the additional field lack support.

Aspect 58: The method of any of Aspects 47-57, wherein the UE capability information message prioritizes indicating the one or more UE capabilities associated with one of the NTN or the TN.

Aspect 59: The method of Aspect 58, further comprising: receiving, from the base station, an indication that the UE is to prioritize indicating the one or more UE capabilities associated with a particular one of the NTN or the TN in the UE capability information message, wherein the UE capability information message prioritizes indicating the one or more UE capabilities associated with the particular one of the NTN or the TN.

Aspect 60: The method of any of Aspects 58-59, further comprising: determining based at least in part on at least one of network information or UE information that the UE is to prioritize indicating the one or more UE capabilities associated with a particular one of the NTN or the TN in the UE capability information message, wherein the UE capability information message prioritizes indicating the one or more UE capabilities associated with the particular one of the NTN or the TN.

Aspect 61: The method of any of Aspects 58-60, wherein the UE capability information message includes an indication that the UE capability information message prioritizes indicating the one or more UE capabilities associated with one of the NTN or the TN.

Aspect 62: The method of any of Aspects 47-61, wherein the UE is an NTN only UE, and the UE capability information message indicates the one or more UE capabilities associated with only the NTN.

Aspect 63: The method of Aspect 62, wherein the UE capability information message includes an indication that the UE is the NTN only UE or that the one or more UE capabilities are associated with only the NTN.

Aspect 64: The method of any of Aspects 47-63, wherein the UE capability information message indicates the one or more UE capabilities using one or more feature group indications.

Aspect 65: A method of wireless communication performed by an apparatus of a base station, comprising: transmitting, to a user equipment (UE), a UE capability request message; and receiving, from the UE in response to the UE capability request message, a UE capability information message that indicates one or more UE capabilities associated with one of a non-terrestrial network (NTN), a terrestrial network (TN), or both the NTN and the TN.

Aspect 66: The method of Aspect 65, further comprising: transmitting, to the UE, an indication that the one or more UE capabilities associated with a particular one of the NTN, the TN, or both the NTN and the TN are to be indicated in the UE capability information message, wherein the UE capability information message indicates the one or more UE capabilities in accordance with the indication.

Aspect 67: The method of any of Aspects 65-66, further comprising: transmitting, to the UE, an indication of one or more bands or band combinations for which the UE capability information message is to indicate per-band UE capabilities, wherein the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

Aspect 68: The method of any of Aspects 65-67, wherein the UE capability information message indicates the one or more UE capabilities associated with the NTN in a field of the UE capability information message designated for capability indication for the TN.

Aspect 69: The method of Aspect 68, wherein the UE capability information message includes an indication that the one or more UE capabilities associated with the NTN are in the field of the UE capability information message designated for capability indication for the TN.

Aspect 70: The method of any of Aspects 65-67, wherein the UE capability information message indicates the one or more UE capabilities associated with the NTN in a field of the UE capability information message designated for capability indication for the NTN.

Aspect 71: The method of Aspect 70, wherein the UE capability information message indicates, in an additional field of the UE capability information message designated for capability indication for the TN, that all features for the additional field lack support.

Aspect 72: The method of any of Aspects 65-71, wherein the UE capability information message prioritizes indicating the one or more UE capabilities associated with one of the NTN or the TN.

Aspect 73: The method of Aspect 72, further comprising: transmitting, to the UE, an indication that the UE is to prioritize indicating the one or more UE capabilities associated with a particular one of the NTN or the TN in the UE capability information message, wherein the UE capability information message prioritizes indicating the one or more UE capabilities associated with the particular one of the NTN or the TN.

Aspect 74: The method of any of Aspects 72-73, wherein the UE capability information message includes an indication that the UE capability information message prioritizes indicating the one or more UE capabilities associated with one of the NTN or the TN.

Aspect 75: The method of any of Aspects 65-74, wherein the UE is an NTN only UE, and the UE capability information message indicates the one or more UE capabilities associated with only the NTN.

Aspect 76: The method of Aspect 65, wherein the UE capability information message includes an indication that the UE is the NTN only UE or that the one or more UE capabilities are associated with only the NTN.

Aspect 77: The method of any of Aspects 65-76, wherein the UE capability information message indicates the one or more UE capabilities using one or more feature group indications.

Aspect 78: A method of wireless communication performed by an apparatus of a user equipment (UE), comprising: receiving, from a base station, a UE capability request message; and transmitting, to the base station in response to the UE capability request message, a UE capability information message that indicates one or more UE capabilities associated with one of unlicensed spectrum, licensed spectrum, or both unlicensed spectrum and licensed spectrum.

Aspect 79: The method of Aspect 78, further comprising: receiving, from the base station, an indication that the one or more UE capabilities associated with a particular one of unlicensed spectrum, licensed spectrum, or both unlicensed spectrum and licensed spectrum are to be indicated in the UE capability information message, wherein the UE capability information message indicates the one or more UE capabilities in accordance with the indication.

Aspect 80: The method of any of Aspects 78-79, further comprising: receiving, from the base station, an indication of one or more bands or band combinations for which the UE capability information message is to indicate per-band UE capabilities, wherein the UE capability information message indicates the one or more UE capabilities associated with the unlicensed spectrum in response to the one or more bands or band combinations including an unlicensed band, and the UE capability information message indicates the one or more UE capabilities associated with licensed spectrum in response to the one or more bands or band combinations including a licensed band.

Aspect 81: The method of any of Aspects 78-80, further comprising: determining based at least in part on network information that the UE is to indicate the one or more UE capabilities associated with a particular one of unlicensed spectrum, licensed spectrum, or both unlicensed spectrum and licensed spectrum in the UE capability information message, wherein the UE capability information message indicates the one or more UE capabilities associated with the particular one of unlicensed spectrum, licensed spectrum, or both unlicensed spectrum and licensed spectrum.

Aspect 82: The method of Aspect 81, where the network information includes at least one of: serving cell information indicating that a serving cell for the UE is operated in unlicensed spectrum or licensed spectrum, or neighboring cell information indicating that a neighboring cell for the UE is operated in unlicensed spectrum or licensed spectrum.

Aspect 83: The method of any of Aspects 78-82, further comprising: determining based at least in part on UE information that the UE is to indicate the one or more UE capabilities associated with a particular one of the unlicensed spectrum, licensed spectrum, or both unlicensed spectrum and licensed spectrum in the UE capability information message, wherein the UE capability information message indicates the one or more UE capabilities for the particular one of unlicensed spectrum, licensed spectrum, or both unlicensed spectrum and licensed spectrum.

Aspect 84: The method of Aspect 83, wherein the UE information includes at least one of: a type of the UE, a location of the UE, a quality of service for communications of the UE, a connection history of the UE, or a speed of movement of the UE.

Aspect 85: The method of any of Aspects 78-84, wherein the UE capability information message indicates the one or more UE capabilities associated with unlicensed spectrum in a field of the UE capability information message designated for capability indication for licensed spectrum.

Aspect 86: The method of Aspect 85, wherein the UE capability information message includes an indication that the one or more UE capabilities associated with unlicensed spectrum are in the field of the UE capability information message designated for capability indication for licensed spectrum.

Aspect 87: The method of any of Aspects 78-84, wherein the UE capability information message indicates the one or more UE capabilities associated with unlicensed spectrum in a field of the UE capability information message designated for capability indication for unlicensed spectrum.

Aspect 88: The method of Aspect 87, wherein the UE capability information message indicates, in an additional field of the UE capability information message designated for capability indication for licensed spectrum, that all features for the additional field lack support.

Aspect 89: The method of any of Aspects 78-88, wherein the UE capability information message prioritizes indicating the one or more UE capabilities associated with one of unlicensed spectrum or licensed spectrum.

Aspect 90: The method of Aspect 89, further comprising: receiving, from the base station, an indication that the UE is to prioritize indicating the one or more UE capabilities associated with a particular one of unlicensed spectrum or licensed spectrum in the UE capability information message, wherein the UE capability information message prioritizes indicating the one or more UE capabilities associated with the particular one of unlicensed spectrum or licensed spectrum.

Aspect 91: The method of any of Aspects 89-90, further comprising: determining based at least in part on at least one of network information or UE information that the UE is to prioritize indicating the one or more UE capabilities associated with a particular one of unlicensed spectrum or licensed spectrum in the UE capability information message, wherein the UE capability information message prioritizes indicating the one or more UE capabilities associated with the particular one of unlicensed spectrum or licensed spectrum.

Aspect 92: The method of any of Aspects 89-91, wherein the UE capability information message includes an indication that the UE capability information message prioritizes indicating the one or more UE capabilities associated with one of unlicensed spectrum or licensed spectrum.

Aspect 93: The method of any of Aspects 78-92, wherein the UE capability information message indicates the one or more UE capabilities using one or more feature group indications.

Aspect 94: A method of wireless communication performed by an apparatus of a base station, comprising: transmitting, to a user equipment (UE), a UE capability request message; and receiving, from the UE in response to the UE capability request message, a UE capability information message that indicates one or more UE capabilities associated with one of unlicensed spectrum, licensed spectrum, or both unlicensed spectrum and licensed spectrum.

Aspect 95: The method of Aspect 94, further comprising: transmitting, to the UE, an indication that the one or more UE capabilities associated with a particular one of unlicensed spectrum, licensed spectrum, or both unlicensed spectrum and licensed spectrum are to be indicated in the UE capability information message, wherein the UE capability information message indicates the one or more UE capabilities in accordance with the indication.

Aspect 96: The method of any of Aspects 94-95, further comprising: transmitting, to the UE, an indication of one or more bands or band combinations for which the UE capability information message is to indicate per-band UE capabilities, wherein the UE capability information message indicates the one or more UE capabilities associated with the unlicensed spectrum in response to the one or more bands or band combinations including an unlicensed band, and the UE capability information message indicates the one or more UE capabilities associated with licensed spectrum in response to the one or more bands or band combinations including a licensed band.

Aspect 97: The method of any of Aspects 94-96, wherein the UE capability information message indicates the one or more UE capabilities associated with unlicensed spectrum in a field of the UE capability information message designated for capability indication for licensed spectrum.

Aspect 98: The method of Aspect 97, wherein the UE capability information message includes an indication that the one or more UE capabilities associated with unlicensed spectrum are in the field of the UE capability information message designated for capability indication for licensed spectrum.

Aspect 99: The method of any of Aspects 94-96, wherein the UE capability information message indicates the one or more UE capabilities associated with unlicensed spectrum in a field of the UE capability information message designated for capability indication for unlicensed spectrum.

Aspect 100: The method of Aspect 99, wherein the UE capability information message indicates, in an additional field of the UE capability information message designated for capability indication for licensed spectrum, that all features for the additional field lack support.

Aspect 101: The method of any of Aspects 94-100, wherein the UE capability information message prioritizes indicating the one or more UE capabilities associated with one of unlicensed spectrum or licensed spectrum.

Aspect 102: The method of Aspect 101, further comprising: transmitting, to the UE, an indication that the UE is to prioritize indicating the one or more UE capabilities associated with a particular one of unlicensed spectrum or licensed spectrum in the UE capability information message, wherein the UE capability information message prioritizes indicating the one or more UE capabilities associated with the particular one of unlicensed spectrum or licensed spectrum.

Aspect 103: The method of any of Aspects 101-102, wherein the UE capability information message includes an indication that the UE capability information message prioritizes indicating the one or more UE capabilities associated with one of unlicensed spectrum or licensed spectrum.

Aspect 104: The method of any of Aspects 94-103, wherein the UE capability information message indicates the one or more UE capabilities using one or more feature group indications.

Aspect 105: An apparatus for wireless communication at a device, comprising a processor; memory coupled with the processor; and instructions stored in the memory and executable by the processor to cause the apparatus to perform the method of one or more of Aspects 47-64.

Aspect 106: A device for wireless communication, comprising a memory and one or more processors coupled to the memory, the one or more processors configured to perform the method of one or more of Aspects 47-64.

Aspect 107: An apparatus for wireless communication, comprising at least one means for performing the method of one or more of Aspects 47-64.

Aspect 108: A non-transitory computer-readable medium storing code for wireless communication, the code comprising instructions executable by a processor to perform the method of one or more of Aspects 47-64.

Aspect 109: A non-transitory computer-readable medium storing a set of instructions for wireless communication, the set of instructions comprising one or more instructions that, when executed by one or more processors of a device, cause the device to perform the method of one or more of Aspects 47-64.

Aspect 110: An apparatus for wireless communication at a device, comprising a processor; memory coupled with the processor; and instructions stored in the memory and executable by the processor to cause the apparatus to perform the method of one or more of Aspects 65-77.

Aspect 111: A device for wireless communication, comprising a memory and one or more processors coupled to the memory, the one or more processors configured to perform the method of one or more of Aspects 65-77.

Aspect 112: An apparatus for wireless communication, comprising at least one means for performing the method of one or more of Aspects 65-77.

Aspect 113: A non-transitory computer-readable medium storing code for wireless communication, the code comprising instructions executable by a processor to perform the method of one or more of Aspects 65-77.

Aspect 114: A non-transitory computer-readable medium storing a set of instructions for wireless communication, the set of instructions comprising one or more instructions that, when executed by one or more processors of a device, cause the device to perform the method of one or more of Aspects 65-77.

Aspect 115: An apparatus for wireless communication at a device, comprising a processor; memory coupled with the processor; and instructions stored in the memory and executable by the processor to cause the apparatus to perform the method of one or more of Aspects 78-93.

Aspect 116: A device for wireless communication, comprising a memory and one or more processors coupled to the memory, the one or more processors configured to perform the method of one or more of Aspects 78-93.

Aspect 117: An apparatus for wireless communication, comprising at least one means for performing the method of one or more of Aspects 78-93.

Aspect 118: A non-transitory computer-readable medium storing code for wireless communication, the code comprising instructions executable by a processor to perform the method of one or more of Aspects 78-93.

Aspect 119: A non-transitory computer-readable medium storing a set of instructions for wireless communication, the set of instructions comprising one or more instructions that, when executed by one or more processors of a device, cause the device to perform the method of one or more of Aspects 78-93.

Aspect 120: An apparatus for wireless communication at a device, comprising a processor; memory coupled with the processor; and instructions stored in the memory and executable by the processor to cause the apparatus to perform the method of one or more of Aspects 94-104.

Aspect 121: A device for wireless communication, comprising a memory and one or more processors coupled to the memory, the one or more processors configured to perform the method of one or more of Aspects 94-104.

Aspect 122: An apparatus for wireless communication, comprising at least one means for performing the method of one or more of Aspects 94-104.

Aspect 123: A non-transitory computer-readable medium storing code for wireless communication, the code comprising instructions executable by a processor to perform the method of one or more of Aspects 94-104.

Aspect 124: A non-transitory computer-readable medium storing a set of instructions for wireless communication, the set of instructions comprising one or more instructions that, when executed by one or more processors of a device, cause the device to perform the method of one or more of Aspects 94-104.

Aspect 125: A method of wireless communication performed by an apparatus of a user equipment (UE), comprising: receiving, from a base station, a UE capability request message that includes an indication that one or more UE capabilities associated with a particular one of a non-terrestrial network (NTN), a terrestrial network (TN), or both the NTN and the TN are to be indicated in a UE capability information message; and transmitting, to the base station in response to the UE capability request message, the UE capability information message that indicates the one or more UE capabilities associated with the particular one of the NTN, the TN, or both the NTN and the TN in accordance with the indication.

Aspect 126: A method of wireless communication performed by an apparatus of a base station, comprising: transmitting, to a user equipment (UE), a UE capability request message that includes an indication that one or more UE capabilities associated with a particular one of a non-terrestrial network (NTN), a terrestrial network (TN), or both the NTN and the TN are to be indicated in a UE capability information message; and receiving, from the UE in response to the UE capability request message, the UE capability information message that indicates the one or more UE capabilities associated with the particular one of the NTN, the TN, or both the NTN and the TN in accordance with the indication.

Aspect 127: A method of wireless communication performed by an apparatus of a user equipment (UE), comprising: receiving, from a base station, a UE capability request message that includes an indication that one or more UE capabilities associated with communication by the UE in a particular one of unlicensed spectrum, licensed spectrum, or both unlicensed spectrum and licensed spectrum are to be indicated in a UE capability information message; and transmitting, to the base station in response to the UE capability request message, the UE capability information message that indicates the one or more UE capabilities associated with the particular one of unlicensed spectrum, licensed spectrum, or both unlicensed spectrum and licensed spectrum in accordance with the indication.

Aspect 128: A method of wireless communication performed by an apparatus of a base station, comprising: transmitting, to a user equipment (UE), a UE capability request message that includes an indication that one or more UE capabilities associated with communication by the UE in a particular one of unlicensed spectrum, licensed spectrum, or both unlicensed spectrum and licensed spectrum are to be indicated in a UE capability information message; and receiving, from the UE in response to the UE capability request message, the UE capability information message that indicates the one or more UE capabilities associated with the particular one of unlicensed spectrum, licensed spectrum, or both unlicensed spectrum and licensed spectrum in accordance with the indication.

Aspect 129: A method of wireless communication performed by an apparatus of a user equipment (UE), comprising: receiving, from a base station, a UE capability request message; and transmitting, to the base station in response to the UE capability request message, a UE capability information message that indicates one or more UE capabilities associated with one of a non-terrestrial network (NTN), a terrestrial network (TN), or both the NTN and the TN in accordance with a determination based at least in part on at least one of network information or UE information that the UE is to indicate the one or more UE capabilities associated with a particular one of the NTN, the TN, or both the NTN and the TN in the UE capability information message.

Aspect 130: A method of wireless communication performed by an apparatus of a user equipment (UE), comprising: receiving, from a base station, a UE capability request message; and transmitting, to the base station in response to the UE capability request message, a UE capability information message that indicates one or more UE capabilities associated with communication in one of unlicensed spectrum, licensed spectrum, or both unlicensed spectrum and licensed spectrum in accordance with a determination based at least in part on at least one of network information or UE information that the UE is to indicate the one or more UE capabilities associated with communication in a particular one of unlicensed spectrum, licensed spectrum, or both unlicensed spectrum and licensed spectrum in the UE capability information message.

Aspect 131: An apparatus for wireless communication at a device, comprising a processor; memory coupled with the processor; and instructions stored in the memory and executable by the processor to cause the apparatus to perform the method of one of Aspects 125-130.

Aspect 132: A device for wireless communication, comprising a memory and one or more processors coupled to the memory, the one or more processors configured to perform the method of one of Aspects 125-130.

Aspect 133: An apparatus for wireless communication, comprising at least one means for performing the method of one of Aspects 125-130.

Aspect 134: A non-transitory computer-readable medium storing code for wireless communication, the code comprising instructions executable by a processor to perform the method of one of Aspects 125-130.

Aspect 135: A non-transitory computer-readable medium storing a set of instructions for wireless communication, the set of instructions comprising one or more instructions that, when executed by one or more processors of a device, cause the device to perform the method of one of Aspects 125-130.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors coupled to the memory, the one or more processors configured to:
receive a UE capability request message; and
transmit, in response to the UE capability request message, based at least in part on network information, a UE capability information message that indicates one or more UE capabilities associated with one of a non-terrestrial network (NTN), a terrestrial network (TN), or both the NTN and the TN.

2. The apparatus of claim 1, wherein the one or more processors are further configured to:
receive an indication that the one or more UE capabilities associated with a particular one of the NTN, the TN, or both the NTN and the TN are to be indicated in the UE capability information message,
wherein the UE capability information message indicates the one or more UE capabilities in accordance with the indication.

3. The apparatus of claim 1, wherein the one or more processors are further configured to:
receive an indication of one or more bands or band combinations for which the UE capability information message is to indicate per-band UE capabilities,
wherein the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

4. The apparatus of claim 1, where the network information includes at least one of:
serving cell information indicating that a serving cell for the UE is operated in the NTN or the TN, or
neighbor cell information indicating that a neighboring cell for the UE is operated in the NTN or the TN.

5. The apparatus of claim 1, wherein the UE capability information message, further based at least in part on UE information, indicates the one or more UE capabilities associated with the one of the NTN, the TN, or both the NTN and the TN, the UE information including at least one of:
a type of the UE,
a location of the UE,
a quality of service for communications of the UE,
a connection history of the UE, or
a speed of movement of the UE.

6. The apparatus of claim 1, wherein the UE capability information message indicates the one or more UE capabilities associated with the NTN in a field of the UE capability information message designated for capability indication for the TN.

7. The apparatus of claim 1, wherein the UE capability information message indicates the one or more UE capabilities associated with the NTN in a field of the UE capability information message designated for capability indication for the NTN.

8. The apparatus of claim 1, wherein the UE is an NTN only UE, and the UE capability information message indicates the one or more UE capabilities associated with only the NTN.

9. The apparatus of claim 8, wherein the UE capability information message includes an indication that the UE is the NTN only UE or that the one or more UE capabilities are associated with only the NTN.

10. The apparatus of claim 1, wherein the UE capability information message indicates the one or more UE capabilities using one or more feature group indications.

11. The apparatus of claim 1, wherein the one or more processors are further configured to:
receive the network information in one or more of a master information block, a system information block, or UE-dedicated signaling.

12. The apparatus of claim 1, wherein the one or more UE capabilities are one or more per-UE capabilities.

13. An apparatus for wireless communication at a network node, comprising:
a memory; and
one or more processors coupled to the memory, the one or more processors configured to:
transmit a user equipment (UE) capability request message for a UE; and
receive, in response to the UE capability request message, based at least in part on network information, a UE capability information message for the UE that indicates one or more UE capabilities associated with one of a non-terrestrial network (NTN), a terrestrial network (TN), or both the NTN and the TN.

14. The apparatus of claim 13, wherein the one or more processors are further configured to:
transmit an indication that the one or more UE capabilities associated with a particular one of the NTN, the TN, or both the NTN and the TN are to be indicated in the UE capability information message,
wherein the UE capability information message indicates the one or more UE capabilities in accordance with the indication.

15. The apparatus of claim 13, wherein the one or more processors are further configured to:
transmit an indication of one or more bands or band combinations for which the UE capability information message is to indicate per-band UE capabilities,
wherein the UE capability information message indicates the one or more UE capabilities associated with the NTN in response to the one or more bands or band combinations including an NTN band, and the UE capability information message indicates the one or more UE capabilities associated with the TN in response to the one or more bands or band combinations including a TN band.

16. The apparatus of claim 13, where the network information includes at least one of:
serving cell information indicating that a serving cell for the UE is operated in the NTN or the TN, or
neighbor cell information indicating that a neighboring cell for the UE is operated in the NTN or the TN.

17. The apparatus of claim 13, wherein the UE capability information message indicates the one or more UE capabilities associated with the NTN in a field of the UE capability information message designated for capability indication for the TN.

18. The apparatus of claim 13, wherein the UE capability information message indicates the one or more UE capabilities associated with the NTN in a field of the UE capability information message designated for capability indication for the NTN.

19. The apparatus of claim 13, wherein the UE is an NTN only UE, and the UE capability information message indicates the one or more UE capabilities associated with only the NTN.

20. The apparatus of claim 19, wherein the UE capability information message includes an indication that the UE is the NTN only UE or that the one or more UE capabilities are associated with only the NTN.

21. The apparatus of claim 13, wherein the UE capability information message indicates the one or more UE capabilities using one or more feature group indications.

22. The apparatus of claim 13, wherein the one or more processors are further configured to:
transmit the network information in one or more of a master information block, a system information block, or UE-dedicated signaling.

23. The apparatus of claim 13, wherein the one or more UE capabilities are one or more per-UE capabilities.

24. A method of wireless communication performed at an apparatus of a user equipment (UE), comprising:
receiving a UE capability request message; and
transmitting, in response to the UE capability request message, based at least in part on network information, a UE capability information message that indicates one or more UE capabilities associated with one of a non-terrestrial network (NTN), a terrestrial network (TN), or both the NTN and the TN.

25. The method of claim 24, where the network information includes at least one of:
serving cell information indicating that a serving cell for the UE is operated in the NTN or the TN, or
neighboring cell information indicating that a neighboring cell for the UE is operated in the NTN or the TN.

26. The method of claim 24, wherein the UE capability information message indicates the one or more UE capabilities associated with the NTN in a field of the UE capability information message designated for capability indication for the TN.

27. The method of claim 24, wherein the UE capability information message indicates the one or more UE capabilities associated with the NTN in a field of the UE capability information message designated for capability indication for the NTN.

28. The method of claim 24, further comprising:
receiving the network information in one or more of a master information block, a system information block, or UE-dedicated signaling.

29. A method of wireless communication performed at an apparatus of a network node, comprising:
transmitting a user equipment (UE) capability request message for a UE; and
receiving, in response to the UE capability request message, based at least in part on network information, a UE capability information message for the UE that indicates one or more UE capabilities associated with one of a non-terrestrial network (NTN), a terrestrial network (TN), or both the NTN and the TN.

30. The method of claim 29, further comprising:
transmitting the network information in one or more of a master information block, a system information block, or UE-dedicated signaling.
